(19) United States
(12) Patent Application Publication
(10) Pub. No.: US 2026/0036795 A1
(43) Pub. Date: Feb. 5, 2026

(54) VARIABLE MAGNIFICATION OPTICAL SYSTEM

(71) Applicant: SIGMA CORPORATION, Kanagawa (JP)

(72) Inventor: Ryo SHIOTA, Kanagawa (JP)

(73) Assignee: SIGMA CORPORATION, Kanagawa (JP)

(21) Appl. No.: 19/258,186

(22) Filed: Jul. 2, 2025

(30) Foreign Application Priority Data
Aug. 2, 2024 (JP) 2024-126493

(51) Int. Cl. G02B 15/14; G02B 15/16

(52) U.S. Cl. CPC G02B 15/1465; G02B 15/16

(57) ABSTRACT

A variable magnification optical system that is relatively compact while suppressing various aberrations such as spherical aberration and field curvature over the entire variable magnification range. The variable magnification optical system includes, in order from the object side, a first lens group G1 having a negative refractive power, a second lens group G2 having a positive refractive power, a third lens group G3 having a positive refractive power, and an image surface side lens group GR. During variable magnification from the wide-angle end to the telephoto end, the air distance between the first lens group G1 and the second lens group G2 decreases, the air distance between the second lens group G2 and the third lens group G3 changes, and the air distance between the third lens group G3 and the image surface side lens group GR increases. The variable magnification optical system satisfies predetermined conditional expressions.

### BACKGROUND OF THE INVENTION

### Field of the Invention

The present invention relates to an optical system suitable for photographic lenses used in imaging devices such as still cameras and video cameras, and more particularly to a variable magnification optical system that has a relatively large aperture ratio, and is compact and lightweight, while correcting various aberrations such as field curvature over the entire variable magnification range.

### Background Art

In recent years, with the increase in the number of pixels in digital cameras and the like, there has been an increasing demand for strict correction of various aberrations in the optical systems used.

On the other hand, with the rise of smartphones and other devices, there is an increasing demand for optical systems suitable for digital cameras with large image sensors, which allow for photography that makes use of more pronounced bokeh for differentiation.

However, in optical systems with bright F numbers that allow large bokeh expression, which have been conventionally proposed, complex lens configurations are often employed to correct various aberrations such as spherical aberration and field curvature, making it difficult to achieve downsizing.

The technology related to the above is disclosed in Patent Documents 1 and 2, for example.

### RELATED ART DOCUMENTS

### Patent Documents

[Patent Document 1] JP-A-2021-196572
[Patent Document 2] JP-A-2021-139930

### SUMMARY OF THE INVENTION

In Patent Document 1, a variable magnification optical system having a relatively large aperture ratio and a relatively short total lens length has been proposed. However, the variable magnification optical system in Patent Document 1 tends to exhibit deteriorated field curvature at an intermediate focal length in examples where the total lens length does not change with magnification, and also tends to exhibit degraded axial chromatic aberration and lateral chromatic aberration at the telephoto end, which is not preferable.

In Patent Document 2, a variable magnification optical system having a relatively large aperture ratio suppressing various aberrations over the entire variable magnification range has been proposed. However, the variable magnification optical system in Patent Document 2 involves a significant change in the total lens length due to variable magnification and requires driving the heaviest lens group located closest to the object side, which makes it difficult to achieve both mechanical strength and weight reduction, and is therefore not preferable.

The present invention aims to provide a variable magnification optical system that, by appropriately setting the distance between lens groups, is relatively compact while suppressing various aberrations such as spherical aberration and field curvature over the entire variable magnification range.

A first aspect of the present invention, which serves as means for solving the above problem, provides a variable magnification optical system including, in order from the object side, a first lens group G1 having a negative refractive power, a second lens group G2 having a positive refractive power, a third lens group G3 having a positive refractive power, and an image surface side lens group GR. During variable magnification from the wide-angle end to the telephoto end, the air distance between the first lens group G1 and the second lens group G2 decreases, the air distance between the second lens group G2 and the third lens group G3 changes, and the air distance between the third lens group G3 and the image surface side lens group GR increases. The variable magnification optical system satisfies predetermined conditional expressions:

$$- 0.08 < ( D 23 T - D 23 W ) / ( D 12 W - D 12 T ) < 0.08 ; \qquad ( 1 )$$

$$0.08 < ( D 23 N - D 23 W ) / ( D 12 W - D 12 T ) < 0.4 ; \qquad ( 2 )$$

$$0.08 < ( D 23 N - D 23 T ) / ( D 12 W - D 12 T ) < 0.4 ; and \qquad ( 3 )$$

$$0.5 < ( D 34 T - D 34 W ) / ( D 12 W - D 12 T ) < 2. ; \qquad ( 4 )$$

where:
D12W: the distance between the first lens group G1 and the second lens group G2 at the wide-angle end;
D12T: the distance between the first lens group G1 and the second lens group G2 at the telephoto end;
D23W: the distance between the second lens group G2 and the third lens group G3 at the wide-angle end;
D23N: the distance between the second lens group G2 and the third lens group G3 at the intermediate variable magnification state;
D23T: the distance between the second lens group G2 and the third lens group G3 at the telephoto end;
D34W: the distance between the third lens group G3 and the image surface side lens group GR at the wide-angle end;
D34T: the distance between the third lens group G3 and the image surface side lens group GR at the telephoto end;
fw: the focal length of the entire lens system at the wide-angle end when focused at infinity;
ft: the focal length of the entire lens system at the telephoto end when focused at infinity; and
the intermediate variable magnification state refers to a state in which the focal length of the entire optical system, due to variable magnification, is equal to or near √(fw×ft).

According to the present invention, it is possible to provide a variable magnification optical system that, by appropriately setting the path of each lens group during variable magnification, has a relatively large aperture ratio and is compact, while correcting various aberrations such as spherical aberration and field curvature over the entire variable magnification range.

### BRIEF DESCRIPTION OF THE DRAWINGS

FIG. 1 is a cross-sectional view of a lens at a wide-angle end of a variable magnification optical system in Example 1 when focused at infinity.

FIG. 2 is a longitudinal aberration diagram at the wide-angle end of the variable magnification optical system in Example 1 when focused at infinity.

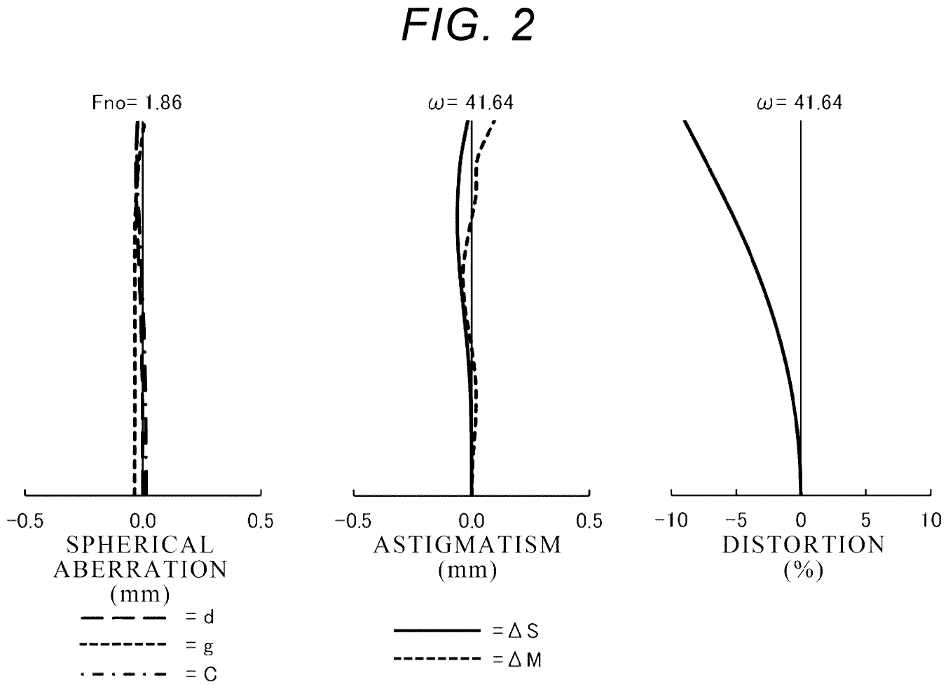

FIG. 3 is a longitudinal aberration diagram at an intermediate focal length of the variable magnification optical system in Example 1 when focused at infinity.

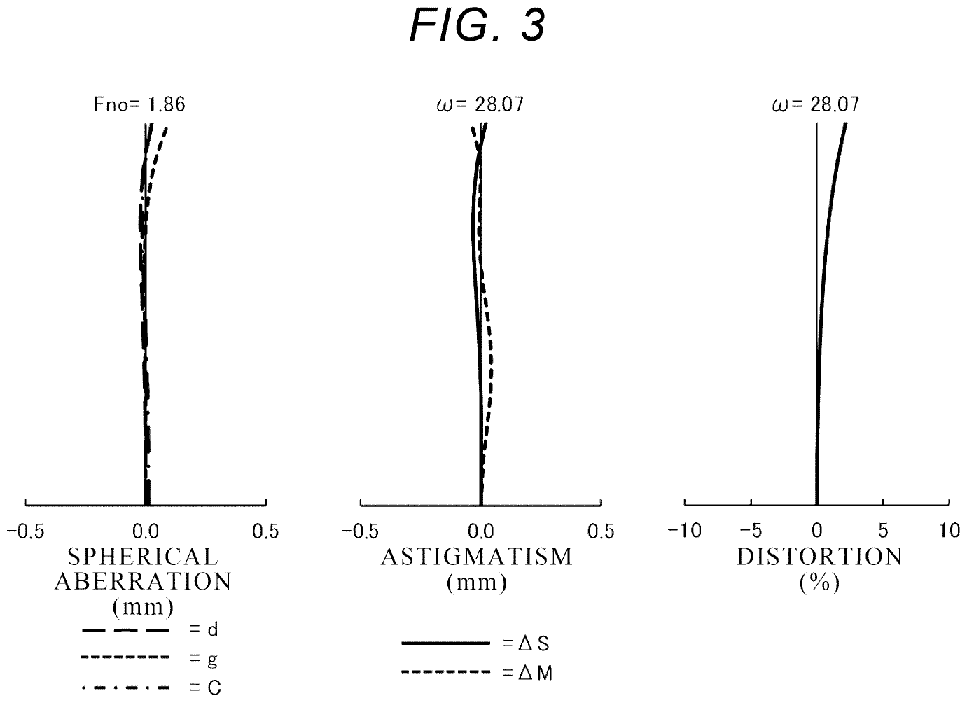

FIG. 4 is a longitudinal aberration diagram at a telephoto end of the variable magnification optical system in Example 1 when focused at infinity.

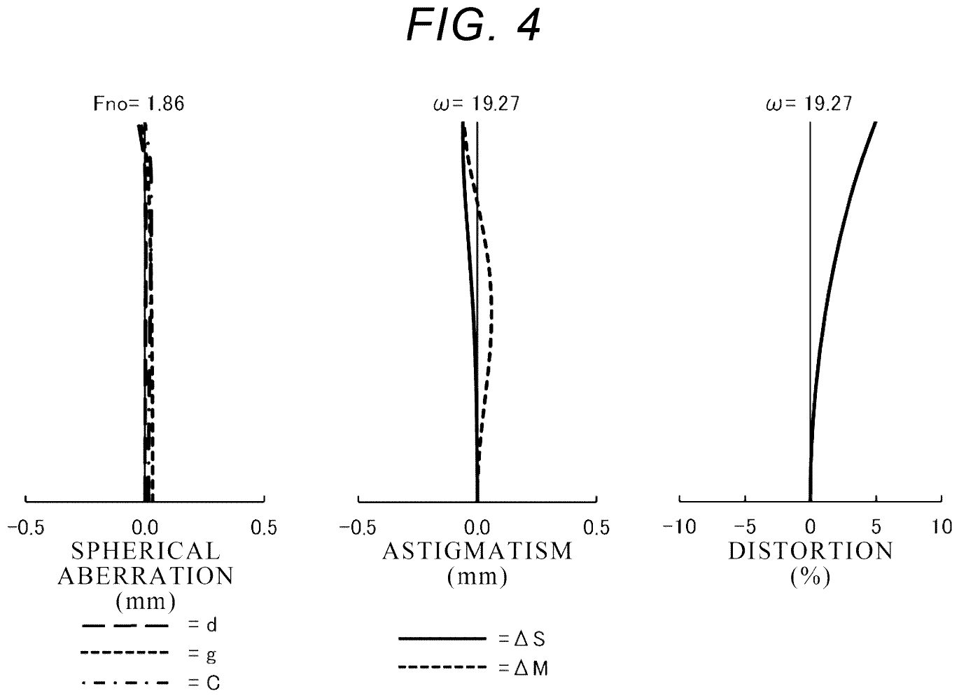

FIG. 5 is a lateral aberration diagram at the wide-angle end of the variable magnification optical system in Example 1 when focused at infinity.

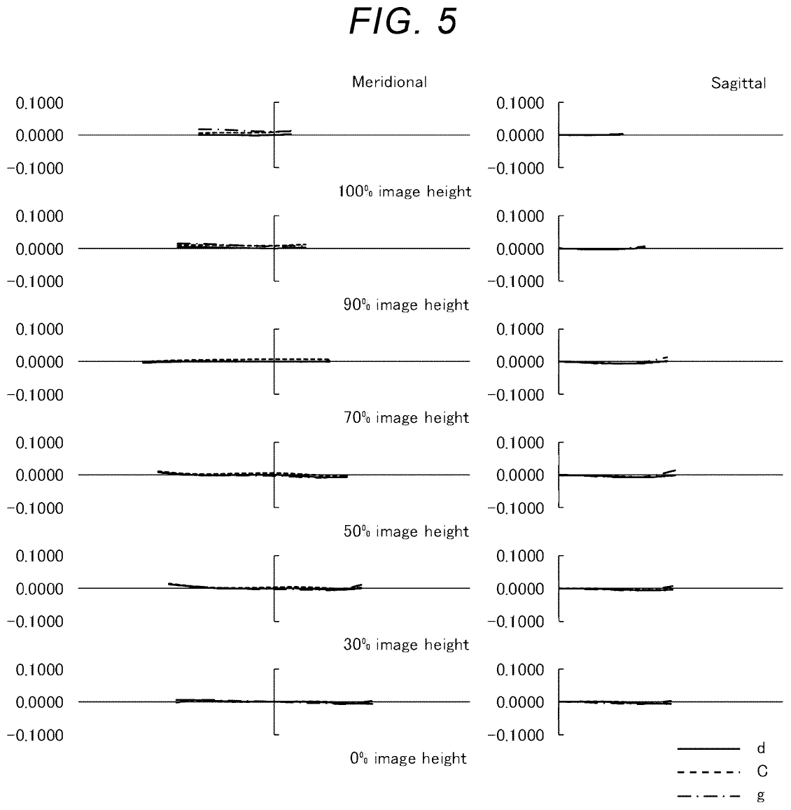

FIG. 6 is a lateral aberration diagram at the intermediate focal length of the variable magnification optical system in Example 1 when focused at infinity.

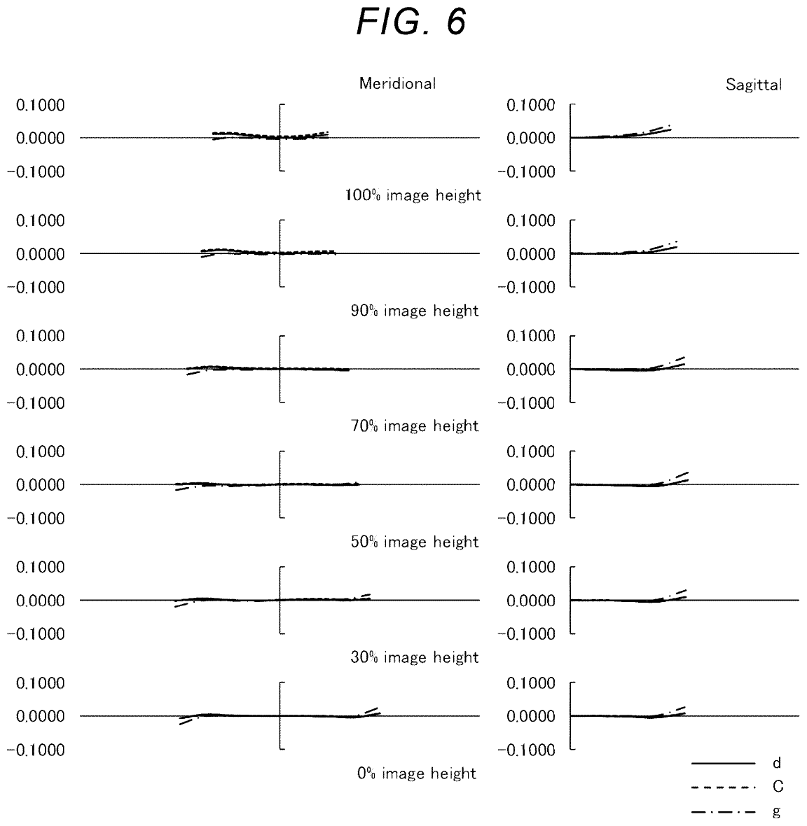

FIG. 7 is a lateral aberration diagram at the telephoto end of the variable magnification optical system in Example 1 when focused at infinity.

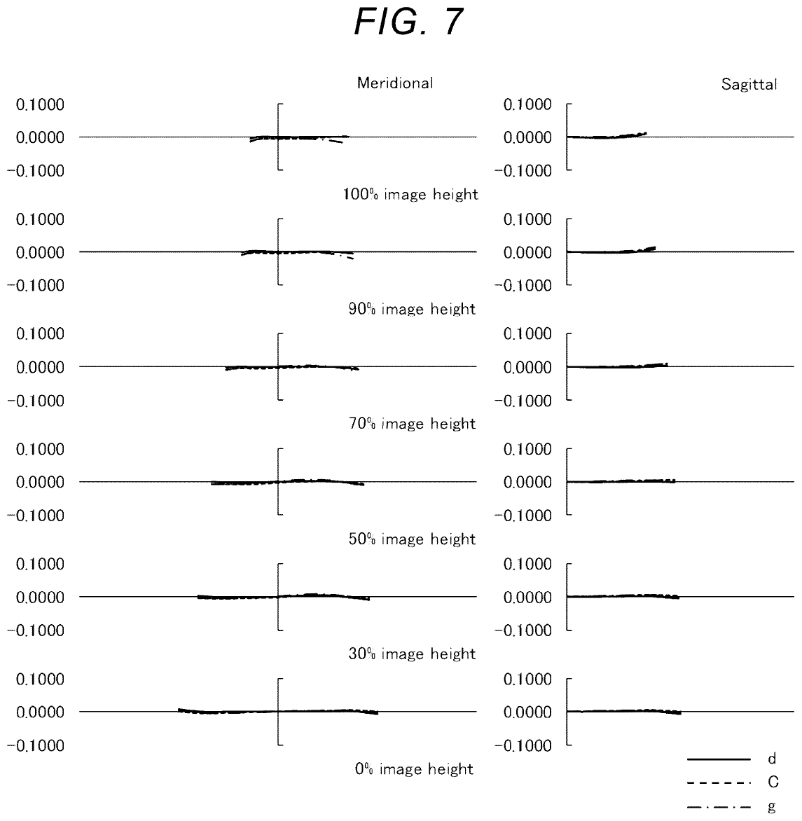

FIG. 8 is a cross-sectional view of a lens at a wide-angle end of a variable magnification optical system in Example 2 when focused at infinity.

FIG. 9 is a longitudinal aberration diagram at the wide-angle end of the variable magnification optical system in Example 2 when focused at infinity.

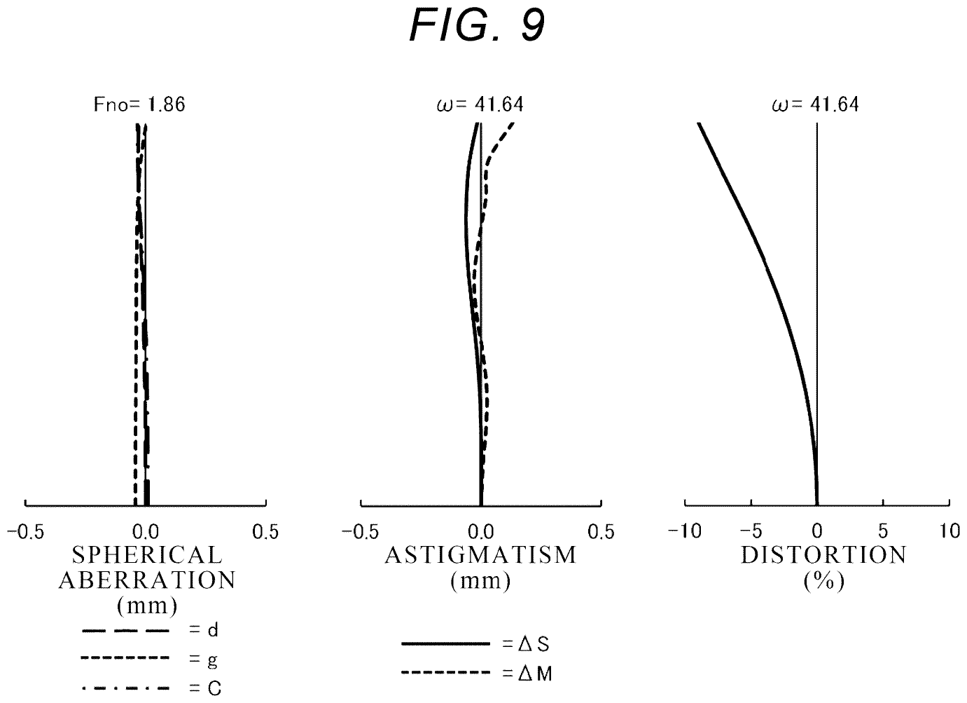

FIG. 10 is a longitudinal aberration diagram at an intermediate focal length of the variable magnification optical system in Example 2 when focused at infinity.

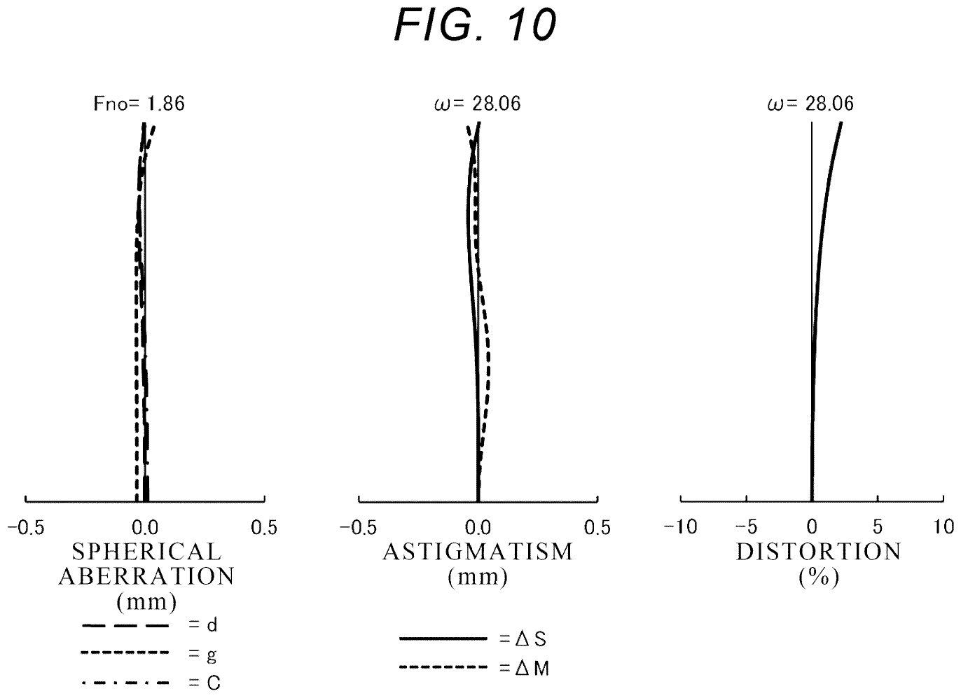

FIG. 11 is a longitudinal aberration diagram at a telephoto end of the variable magnification optical system in Example 2 when focused at infinity.

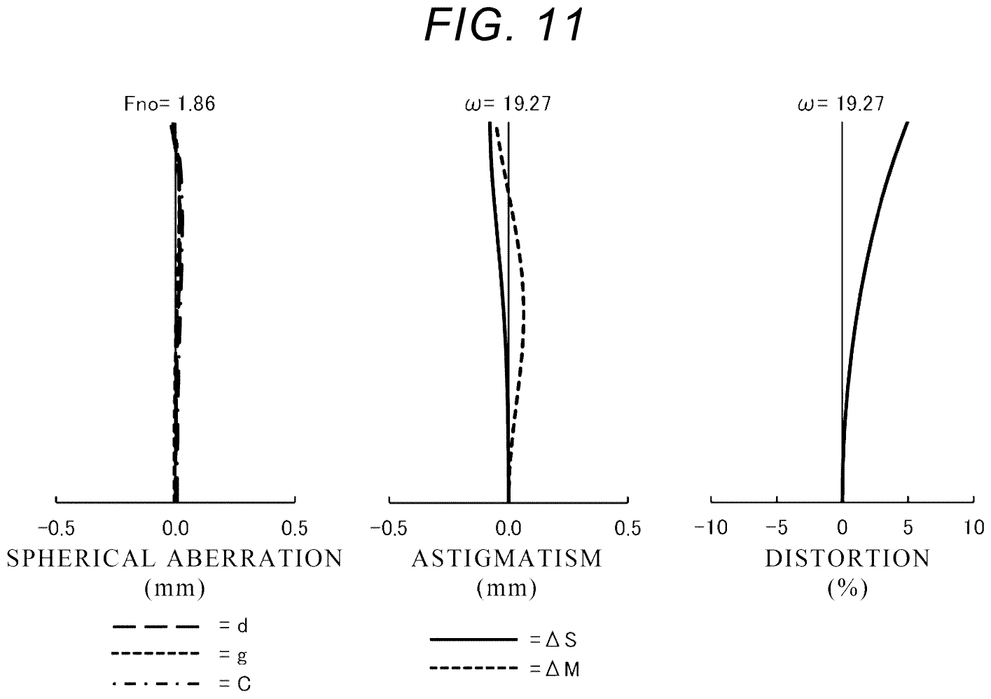

FIG. 12 is a lateral aberration diagram at the wide-angle end of the variable magnification optical system in Example 2 when focused at infinity.

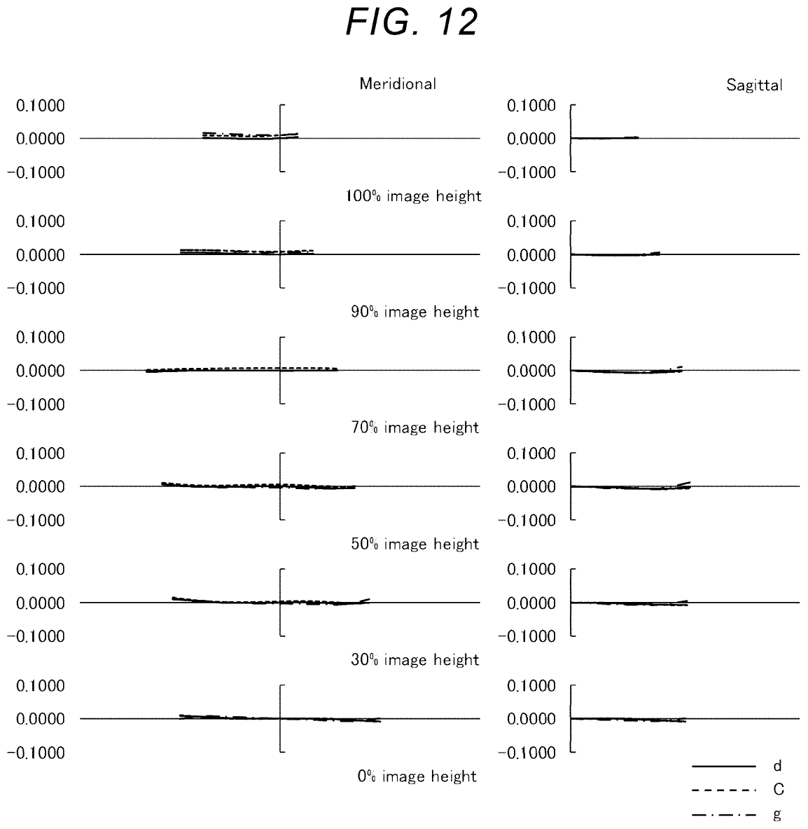

FIG. 13 is a lateral aberration diagram at the intermediate focal length in the variable magnification optical system of Example 2 when focused at infinity.

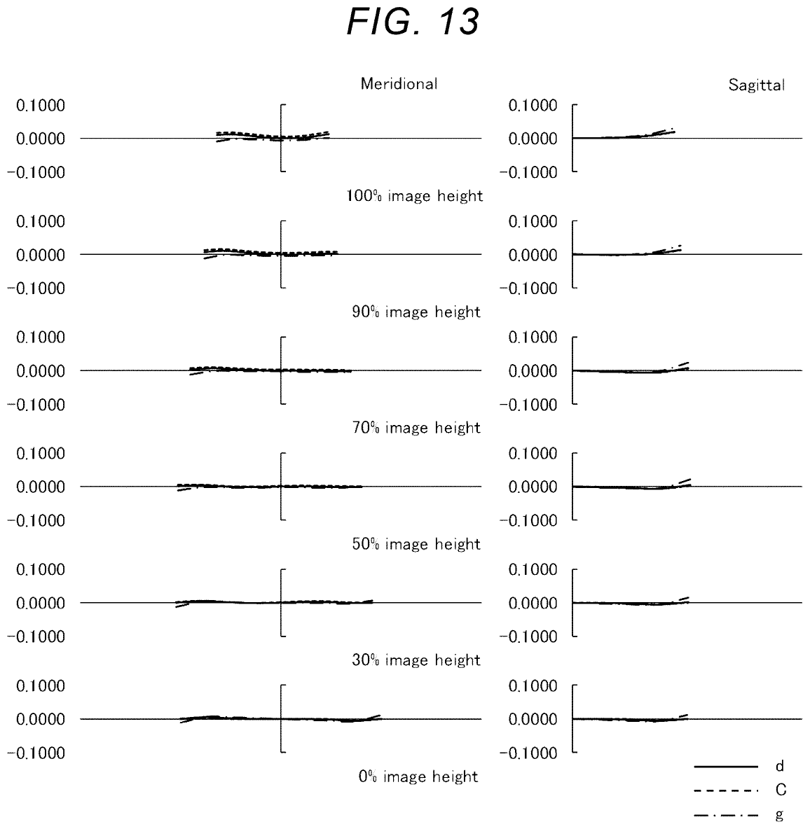

FIG. 14 is a lateral aberration diagram at the telephoto end of the variable magnification optical system in Example 2 when focused at infinity.

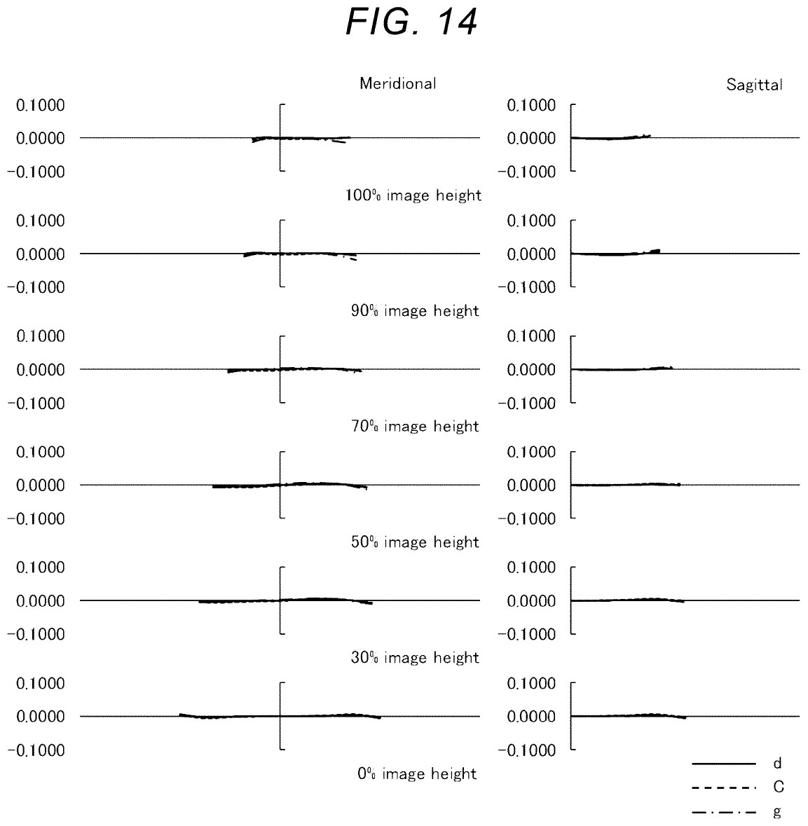

FIG. 15 is a cross-sectional view of a lens at a wide-angle end of a variable magnification optical system in Example 3 when focused at infinity.

FIG. 16 is a longitudinal aberration diagram at the wide-angle end of the variable magnification optical system in Example 3 when focused at infinity.

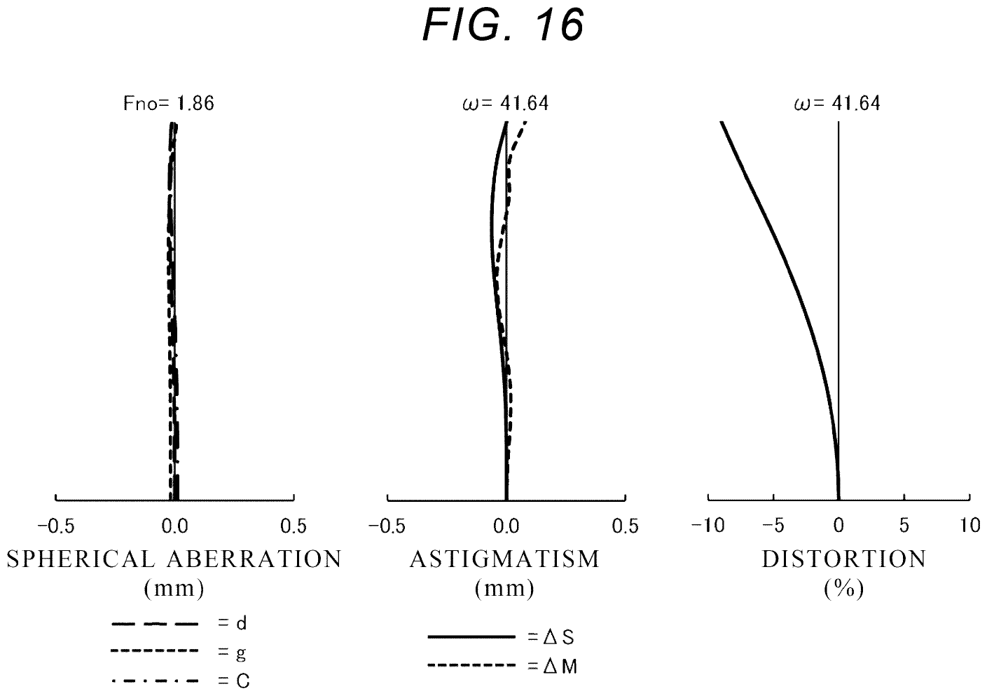

FIG. 17 is a longitudinal aberration diagram at an intermediate focal length of the variable magnification optical system in Example 3 when focused at infinity.

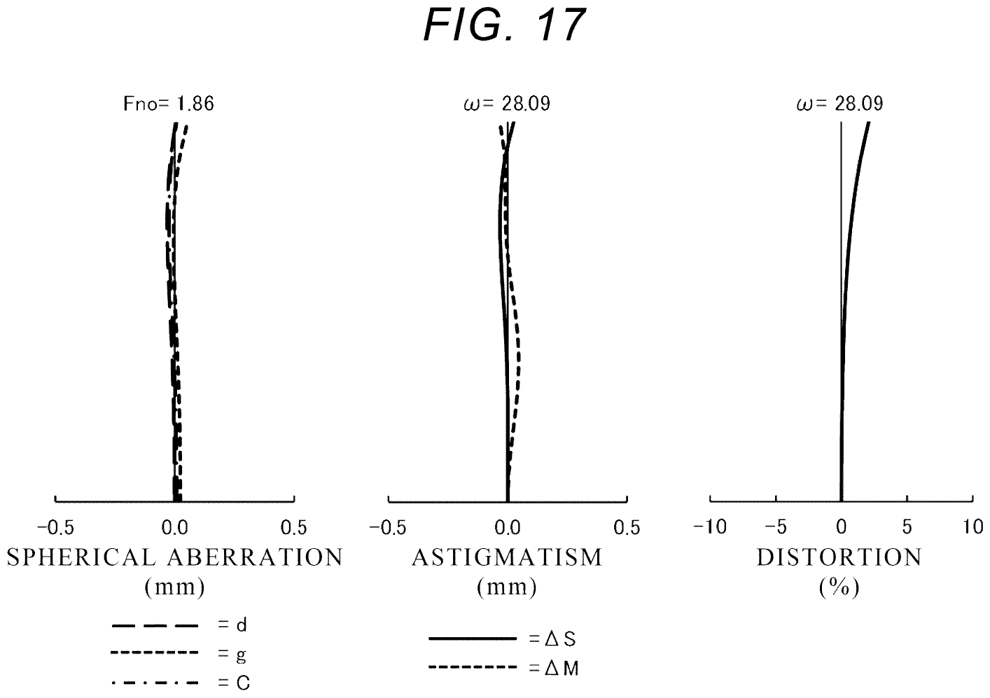

FIG. 18 is a longitudinal aberration diagram at a telephoto end of the variable magnification optical system in Example 3 when focused at infinity.

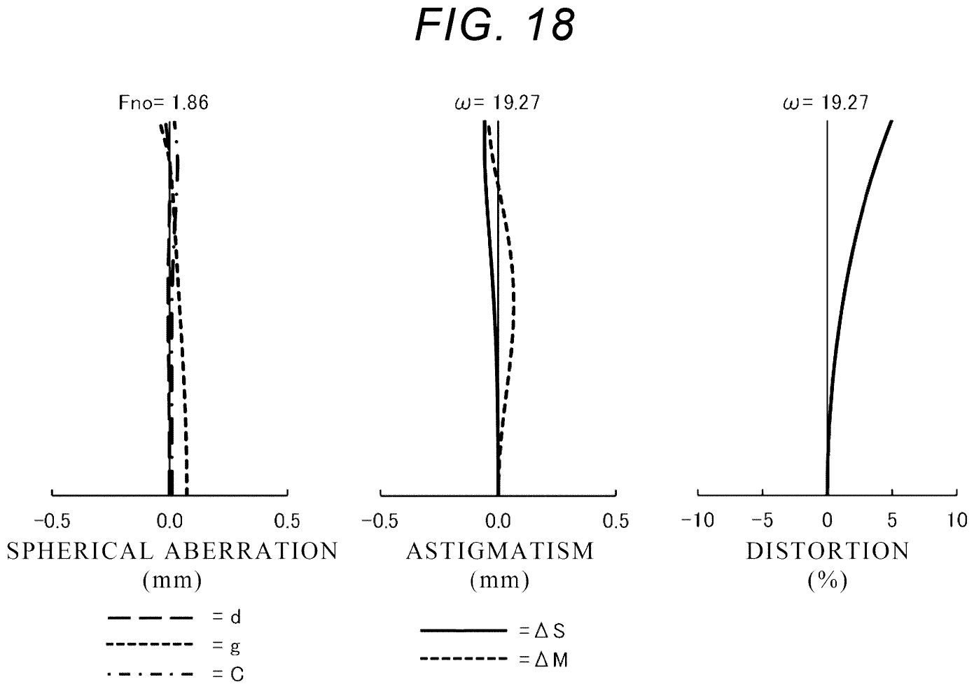

FIG. 19 is a lateral aberration diagram at the wide-angle end of the variable magnification optical system in Example 3 when focused at infinity.

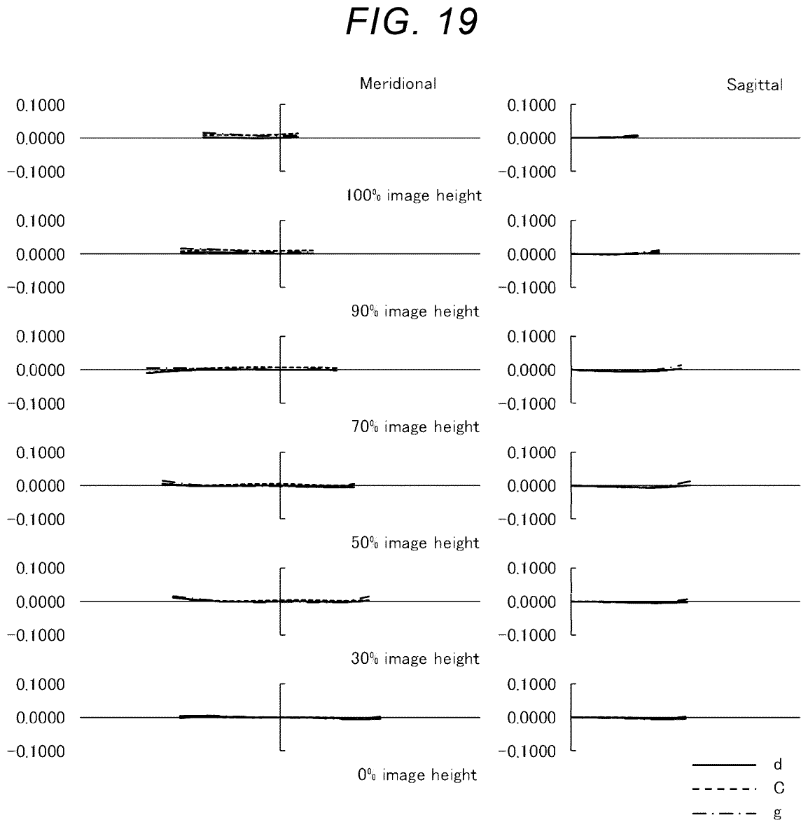

FIG. 20 is a lateral aberration diagram at the intermediate focal length in the variable magnification optical system of Example 3 when focused at infinity.

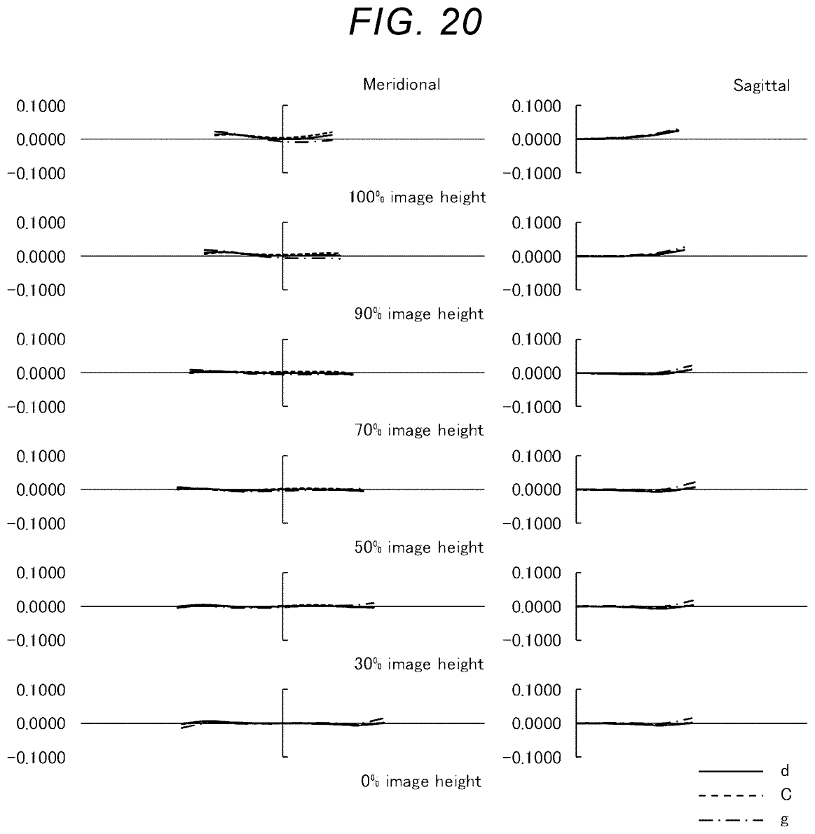

FIG. 21 is a lateral aberration diagram at the telephoto end of the variable magnification optical system in Example 3 when focused at infinity.

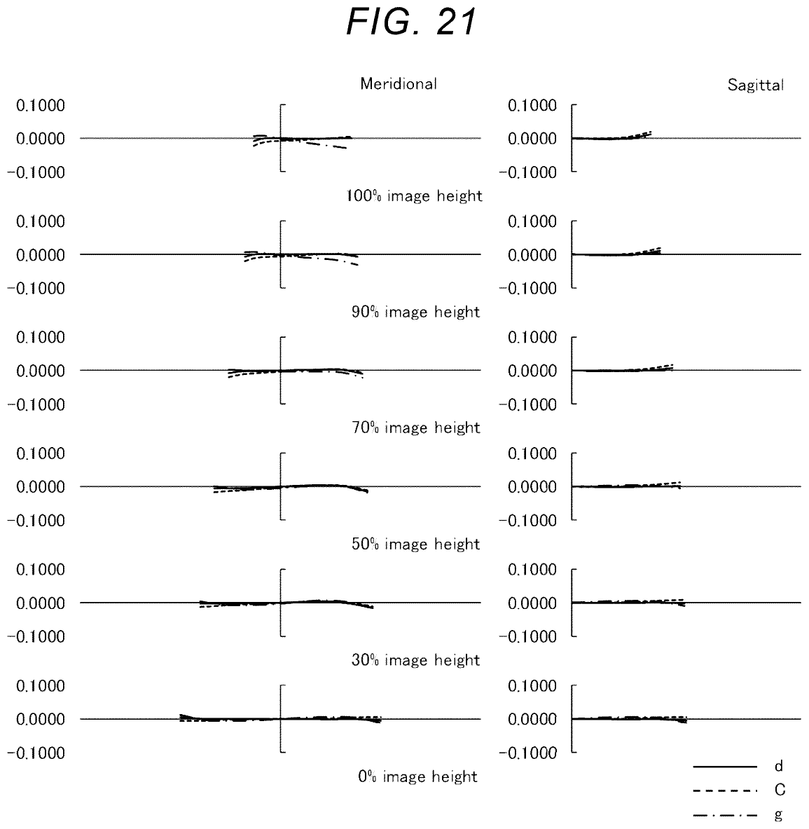

FIG. 22 is a cross-sectional view of a lens at a wide-angle end of a variable magnification optical system in Example 4 when focused at infinity.

FIG. 23 is a longitudinal aberration diagram at the wide-angle end of the variable magnification optical system in Example 4 when focused at infinity.

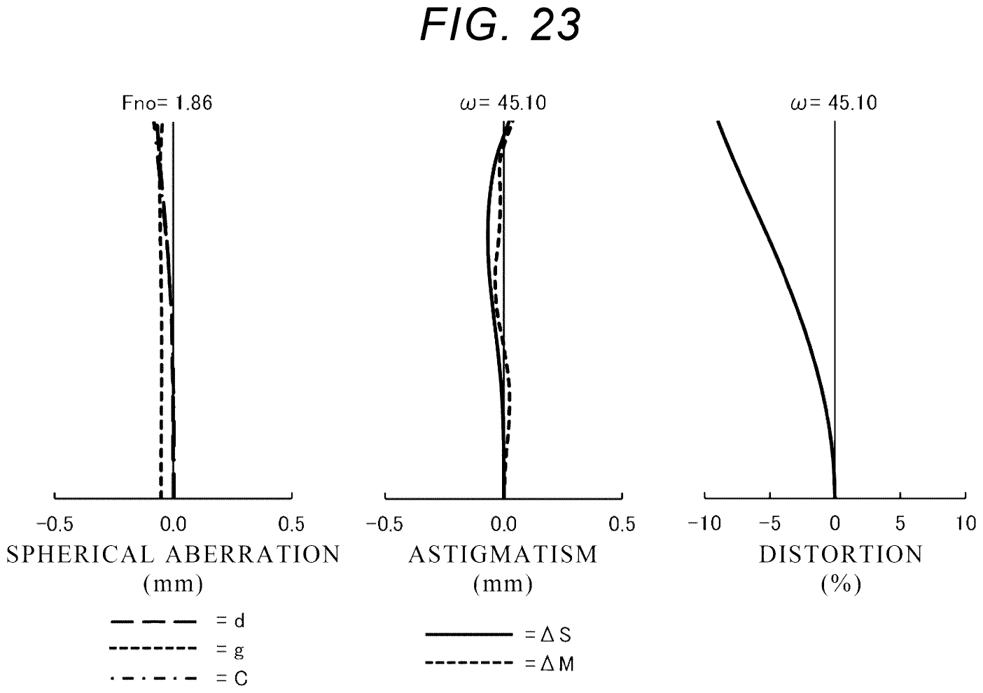

FIG. 24 is a longitudinal aberration diagram at an intermediate focal length of the variable magnification optical system in Example 4 when focused at infinity.

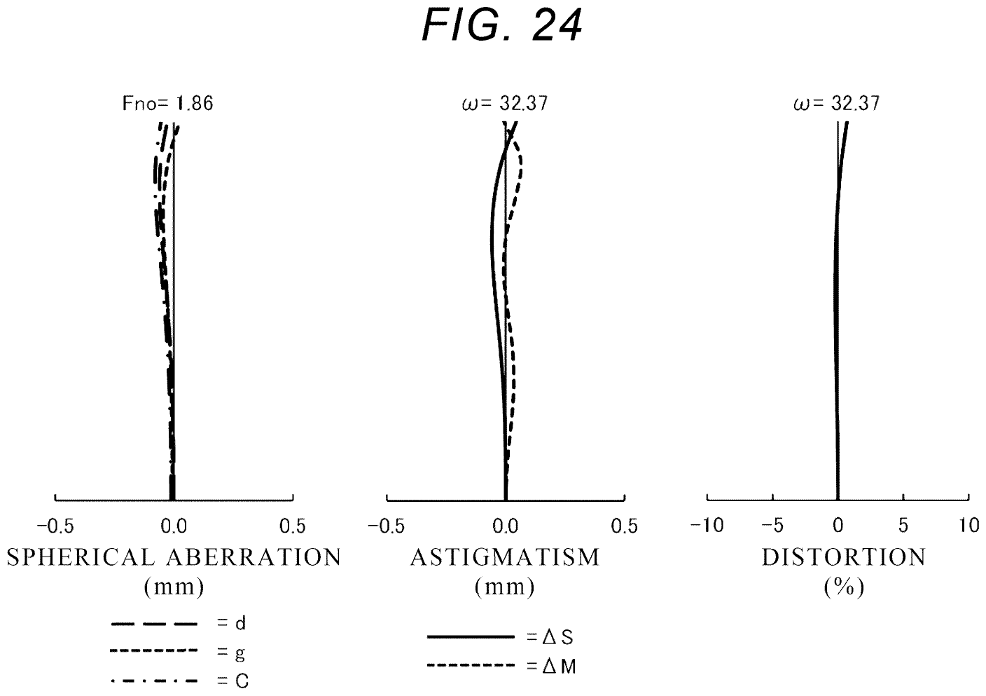

FIG. 25 is a longitudinal aberration diagram at a telephoto end of the variable magnification optical system in Example 4 when focused at infinity.

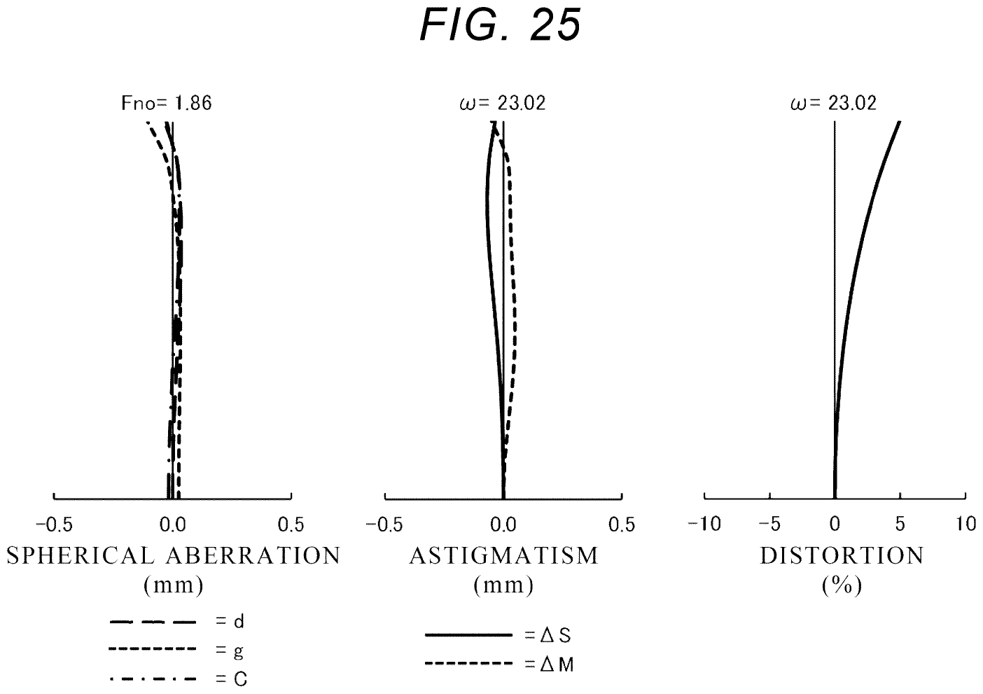

FIG. 26 is a lateral aberration diagram at the wide-angle end of the variable magnification optical system in Example 4 when focused at infinity.

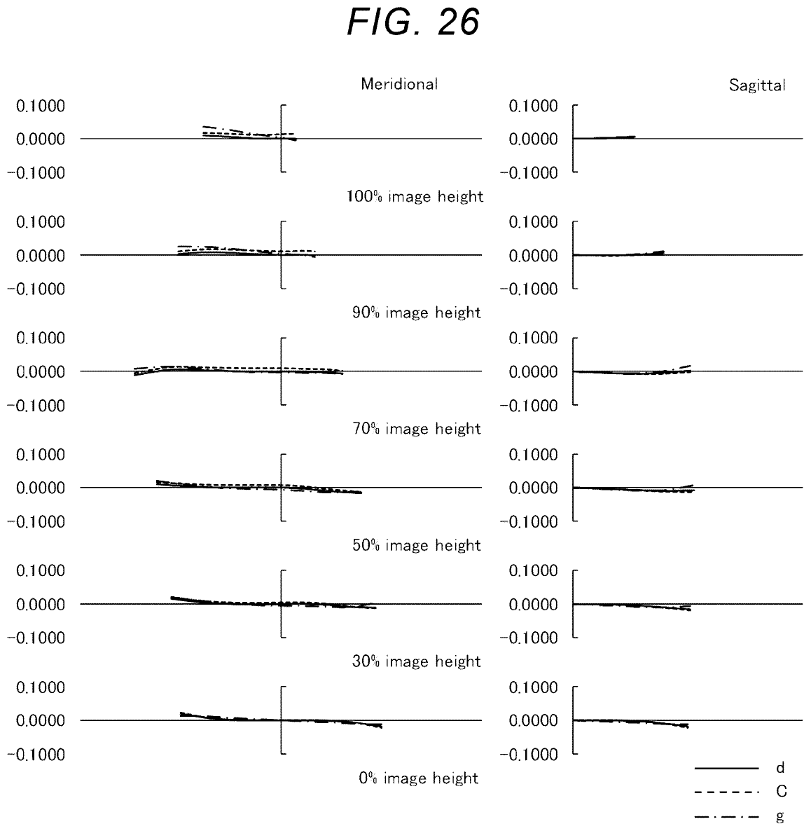

FIG. 27 is a lateral aberration diagram at the intermediate focal length in the variable magnification optical system of Example 4 when focused at infinity.

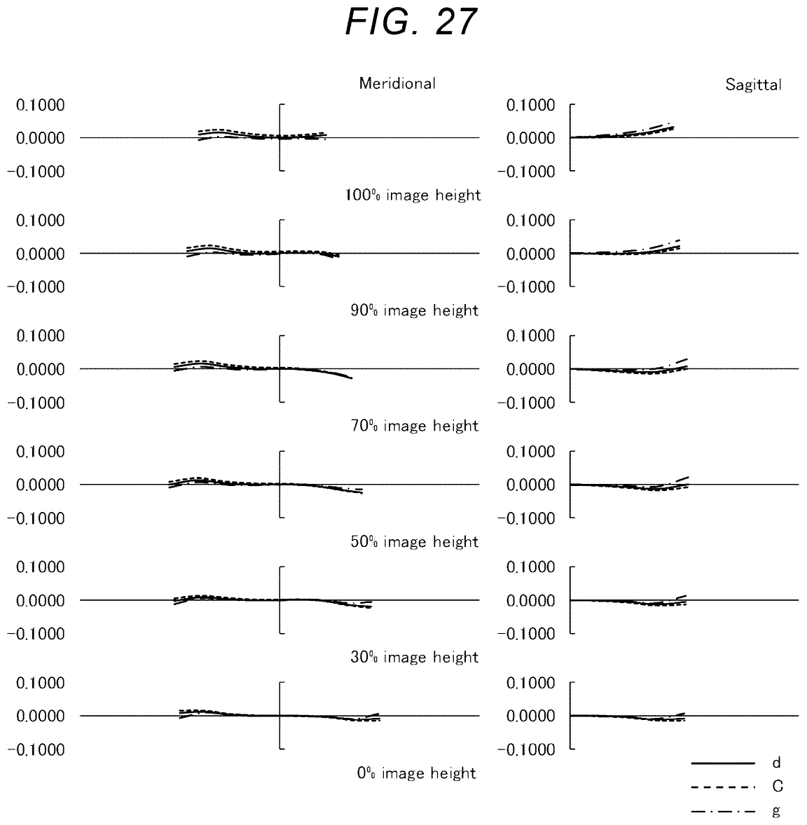

FIG. 28 is a lateral aberration diagram at the telephoto end of the variable magnification optical system in Example 4 when focused at infinity.

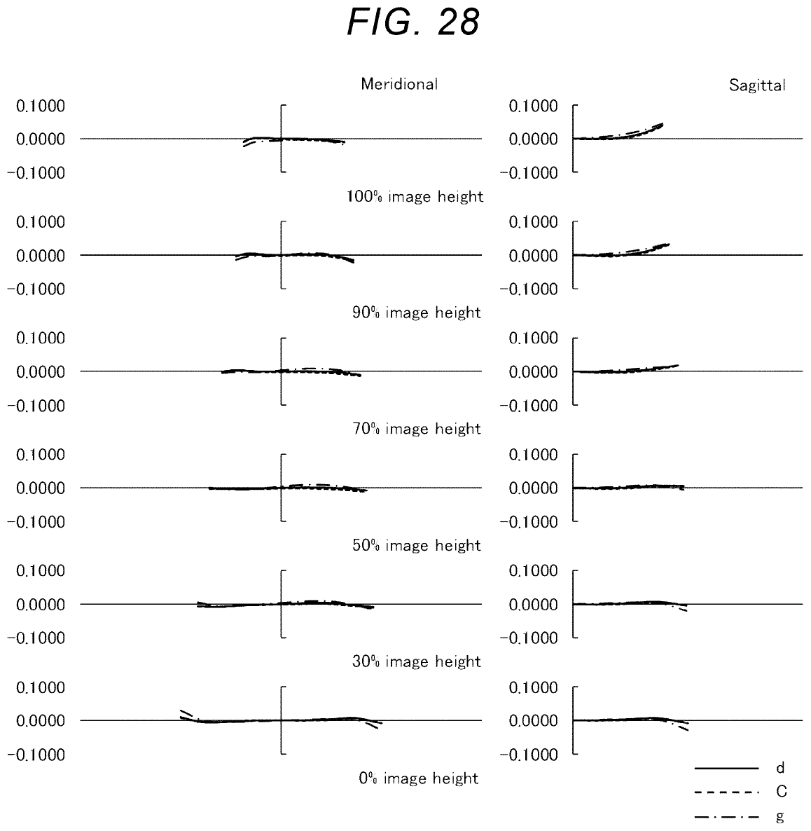

FIG. 29 is a cross-sectional view of a lens at a wide-angle end of a variable magnification optical system in Example 5 when focused at infinity.

FIG. 30 is a longitudinal aberration diagram at the wide-angle end of the variable magnification optical system in Example 5 when focused at infinity.

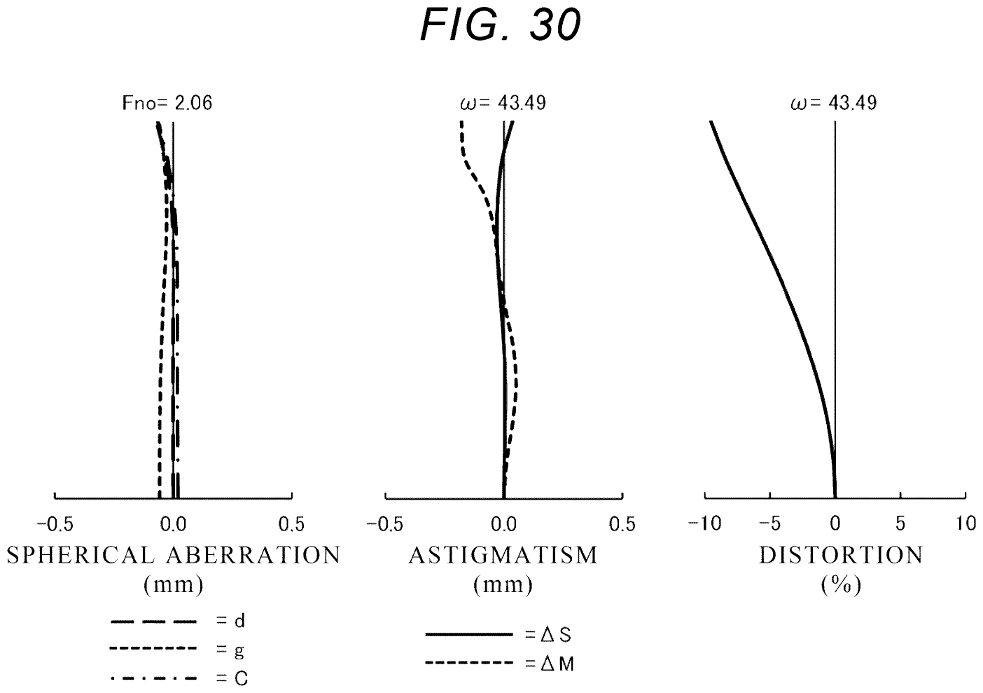

FIG. 31 is a longitudinal aberration diagram at an intermediate focal length of the variable magnification optical system in Example 5 when focused at infinity.

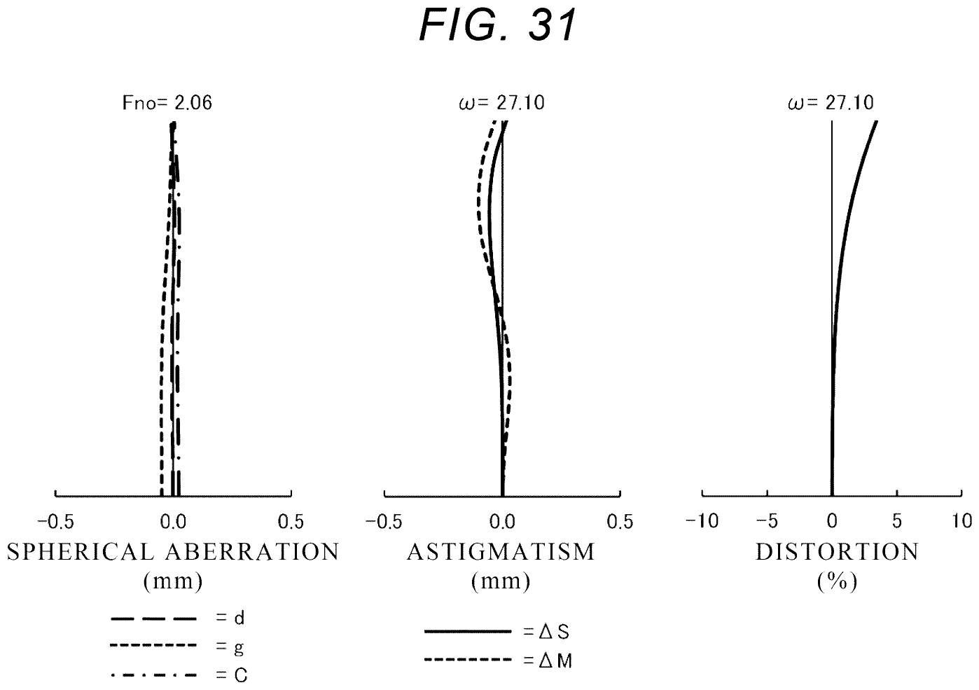

FIG. 32 is a longitudinal aberration diagram at a telephoto end of the variable magnification optical system in Example 5 when focused at infinity.

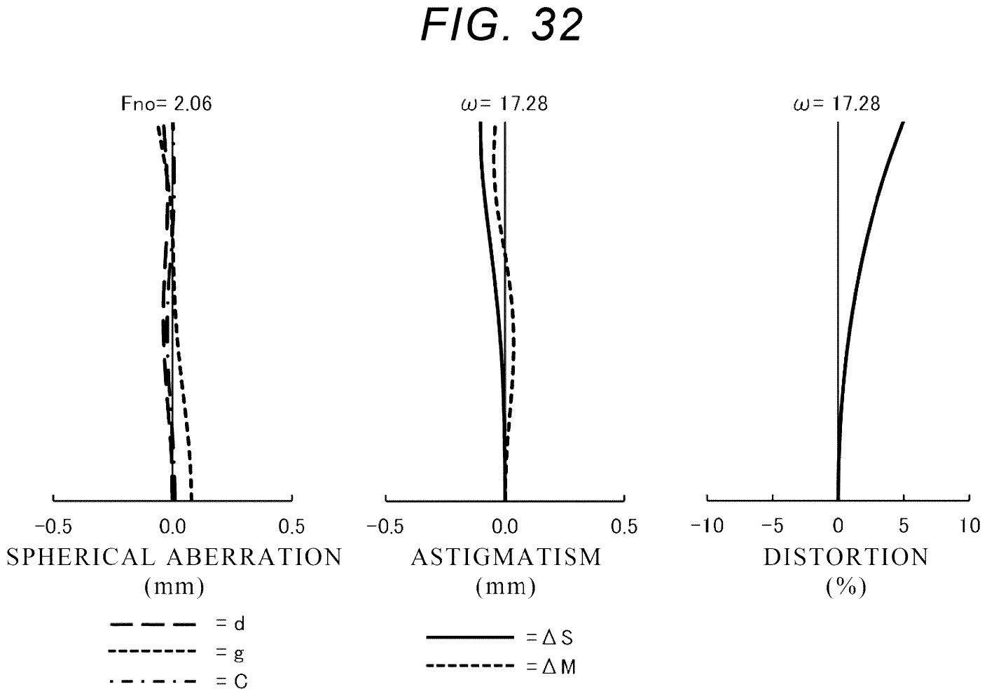

FIG. 33 is a lateral aberration diagram at the wide-angle end of the variable magnification optical system in Example 5 when focused at infinity.

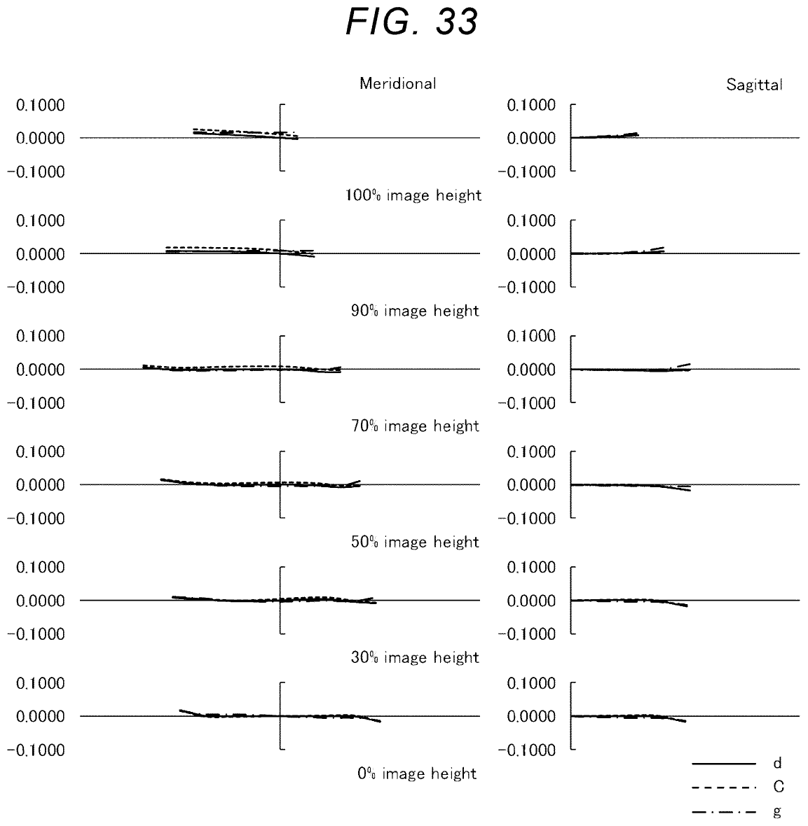

FIG. 34 is a lateral aberration diagram at the intermediate focal length in the variable magnification optical system of Example 5 when focused at infinity.

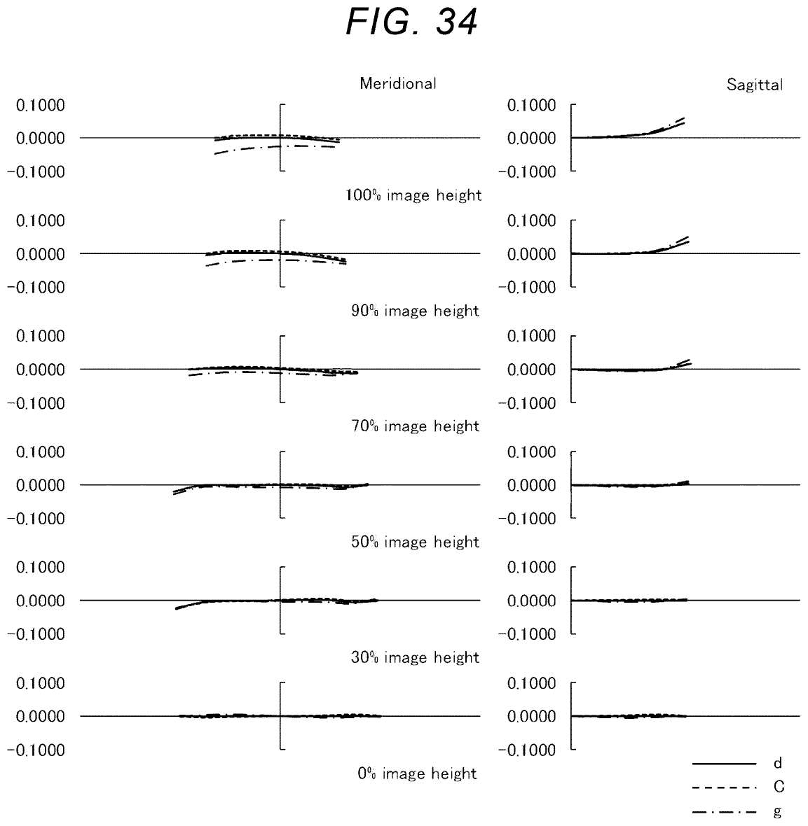

FIG. 35 is a lateral aberration diagram at the telephoto end of the variable magnification optical system in Example 5 when focused at infinity.

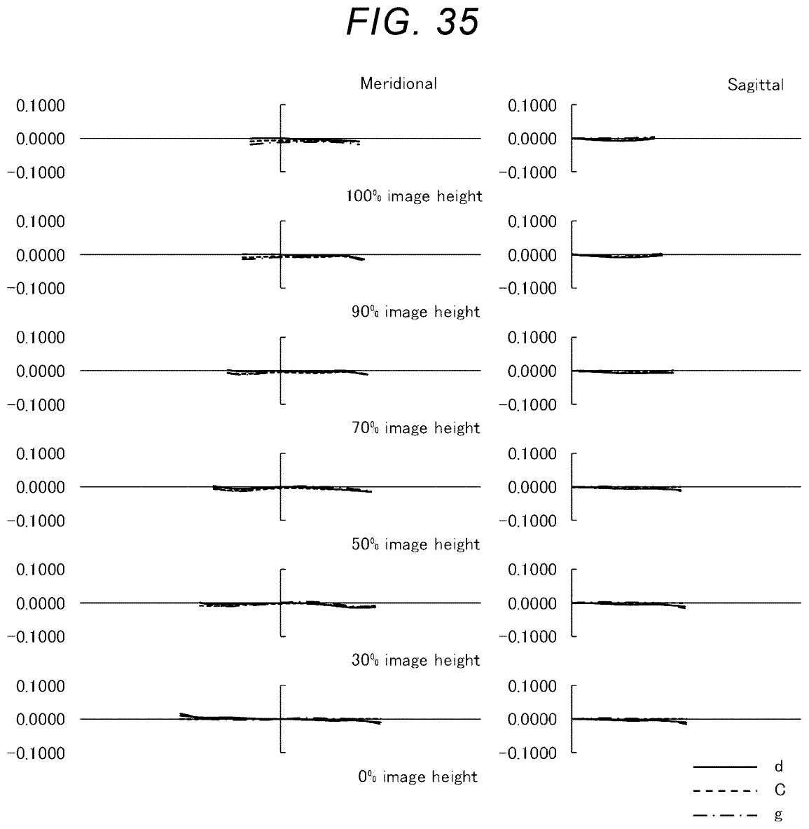

FIG. 36 is a cross-sectional view of a lens at a wide-angle end of a variable magnification optical system in Example 6 when focused at infinity.

FIG. 37 is a longitudinal aberration diagram at the wide-angle end of the variable magnification optical system in Example 6 when focused at infinity.

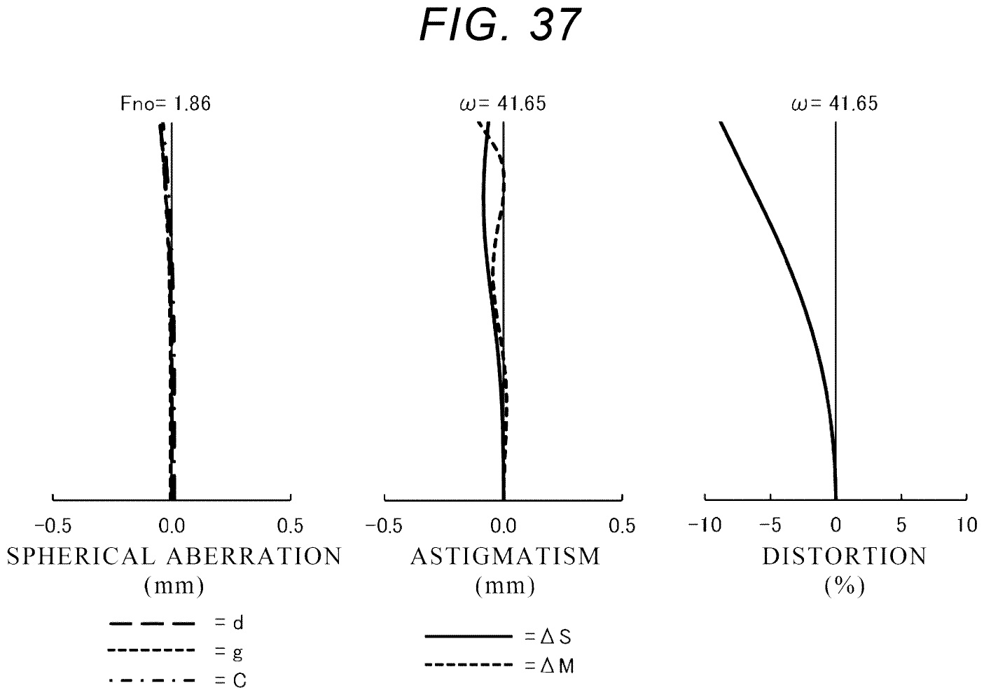

FIG. 38 is a longitudinal aberration diagram at an intermediate focal length of the variable magnification optical system in Example 6 when focused at infinity.

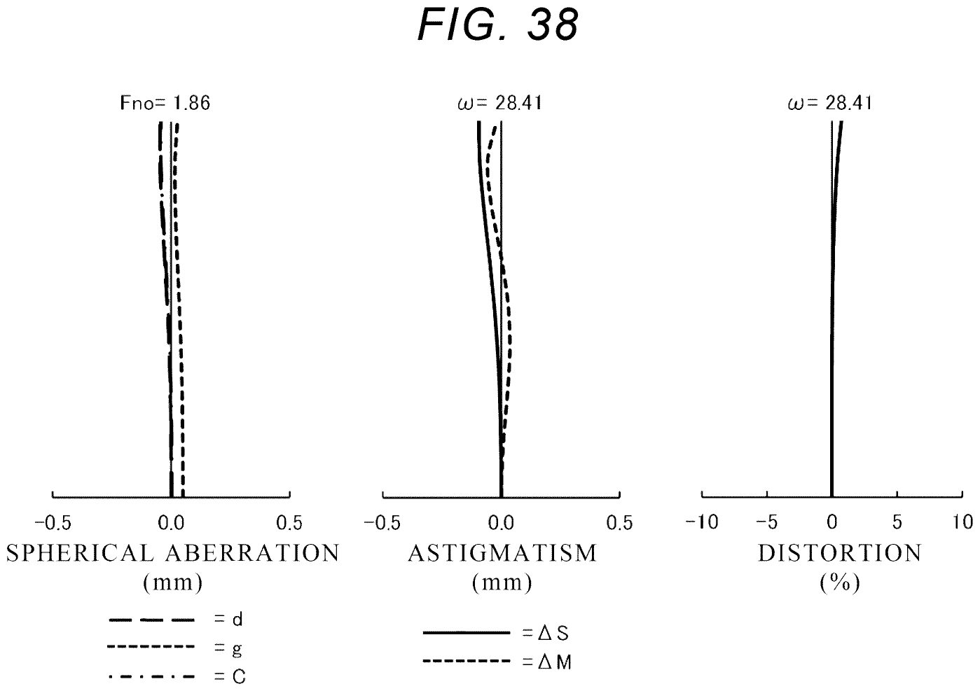

FIG. 39 is a longitudinal aberration diagram at a telephoto end of the variable magnification optical system in Example 6 when focused at infinity.

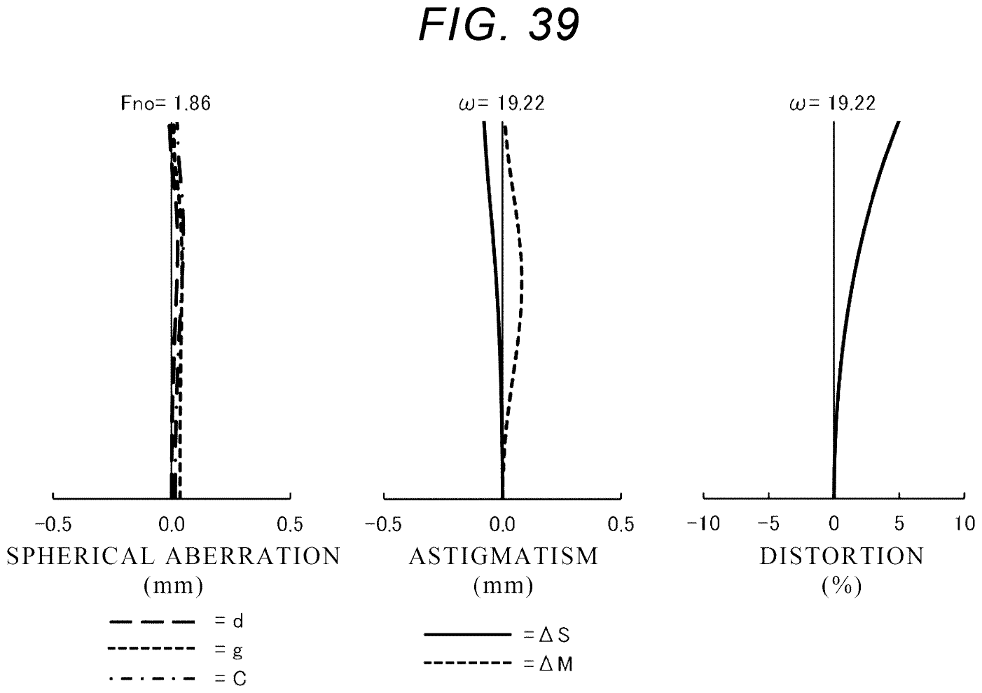

FIG. 40 is a lateral aberration diagram at the wide-angle end of the variable magnification optical system in Example 6 when focused at infinity.

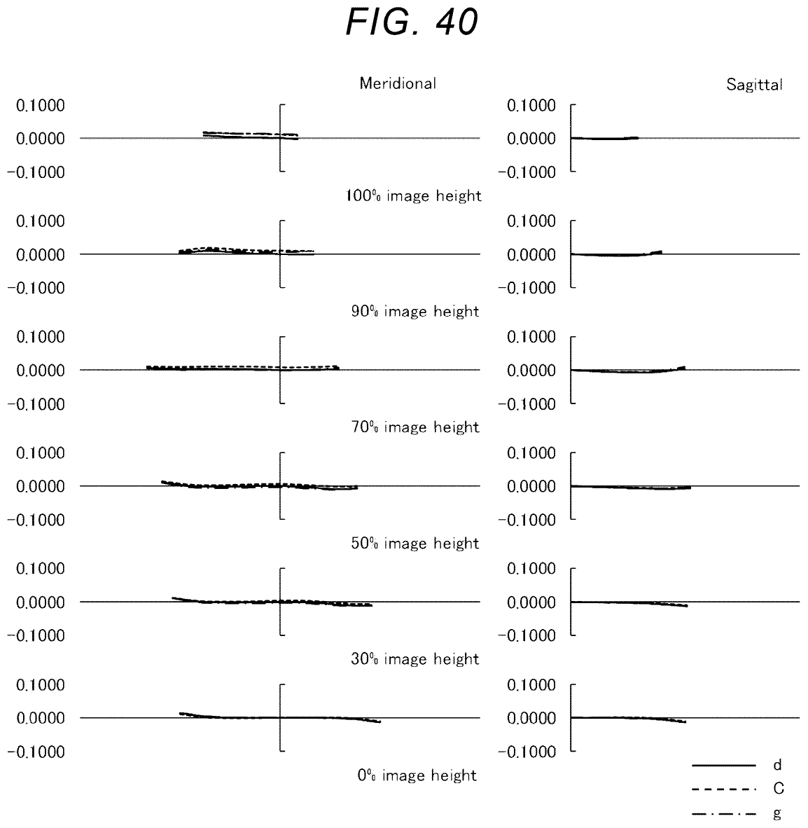

FIG. 41 is a lateral aberration diagram at the intermediate focal length in the variable magnification optical system of Example 6 when focused at infinity.

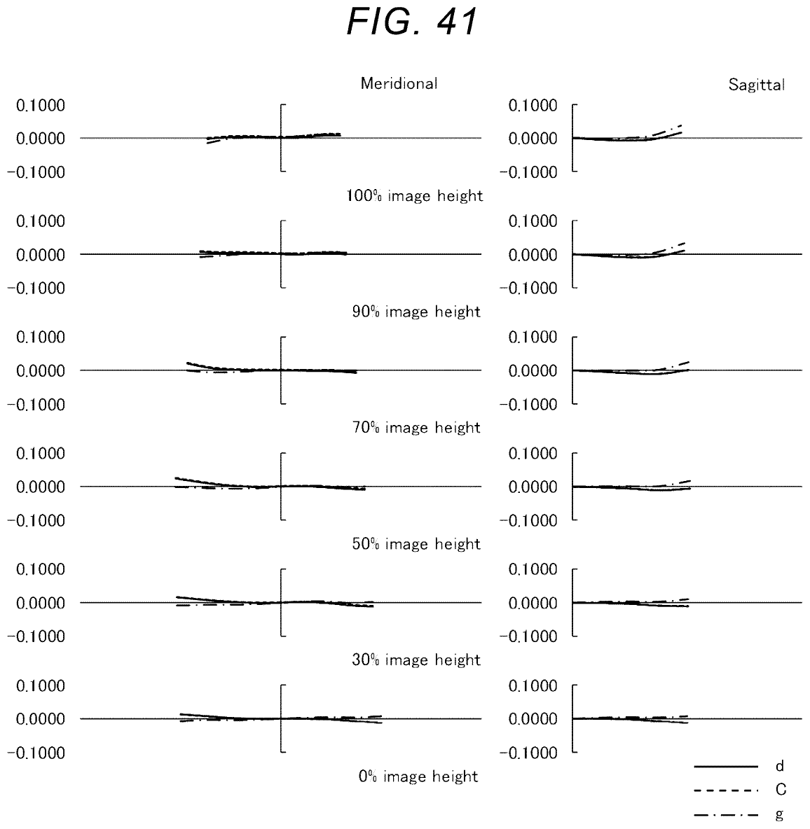

FIG. 42 is a lateral aberration diagram at the telephoto end of the variable magnification optical system in Example 6 when focused at infinity.

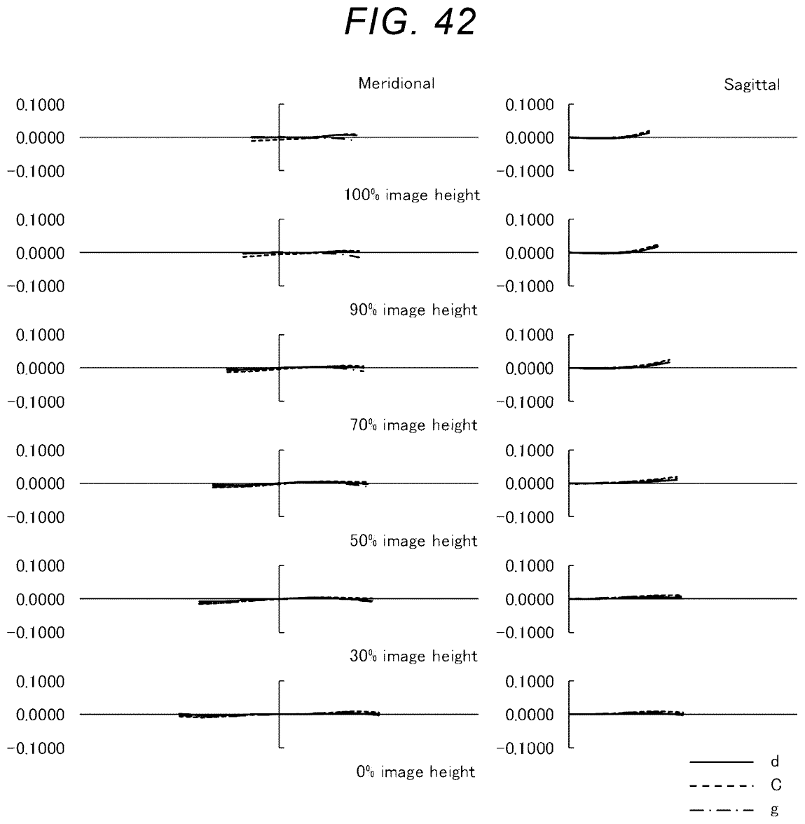

FIG. 43 is a cross-sectional view of a lens at a wide-angle end of a variable magnification optical system in Example 7 when focused at infinity.

FIG. 44 is a longitudinal aberration diagram at the wide-angle end of the variable magnification optical system in Example 7 when focused at infinity.

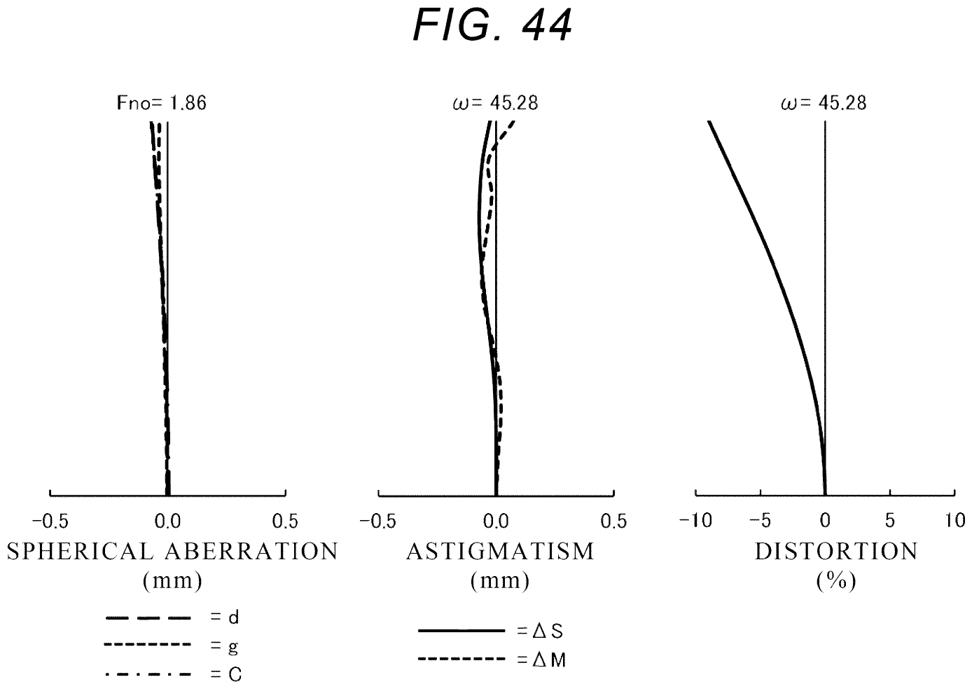

FIG. 45 is a longitudinal aberration diagram at an intermediate focal length of the variable magnification optical system in Example 7 when focused at infinity.

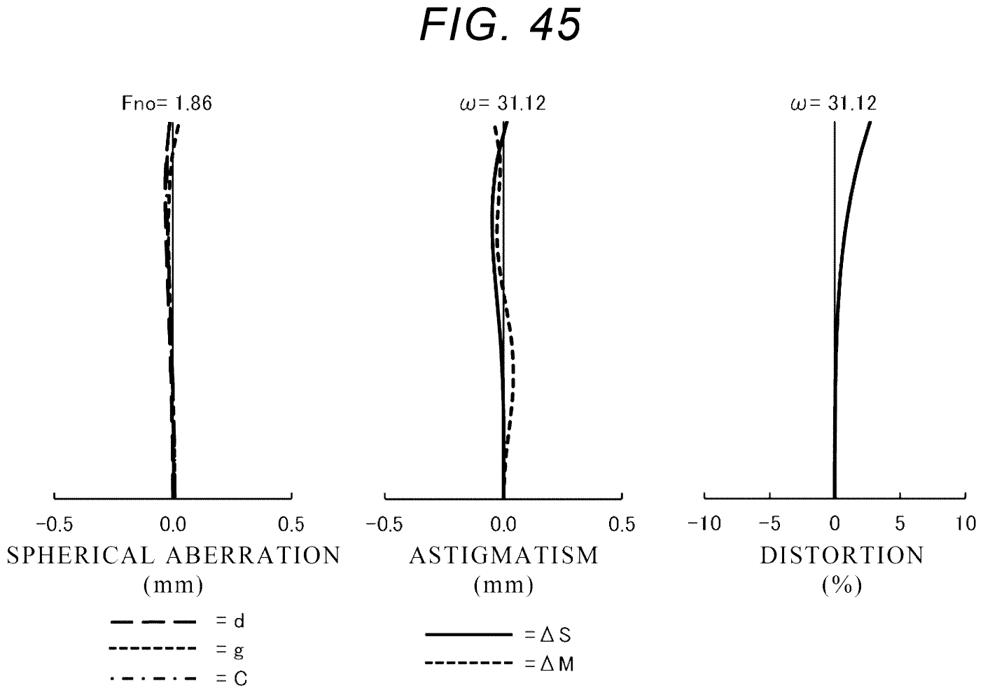

FIG. 46 is a longitudinal aberration diagram at a telephoto end of the variable magnification optical system in Example 7 when focused at infinity.

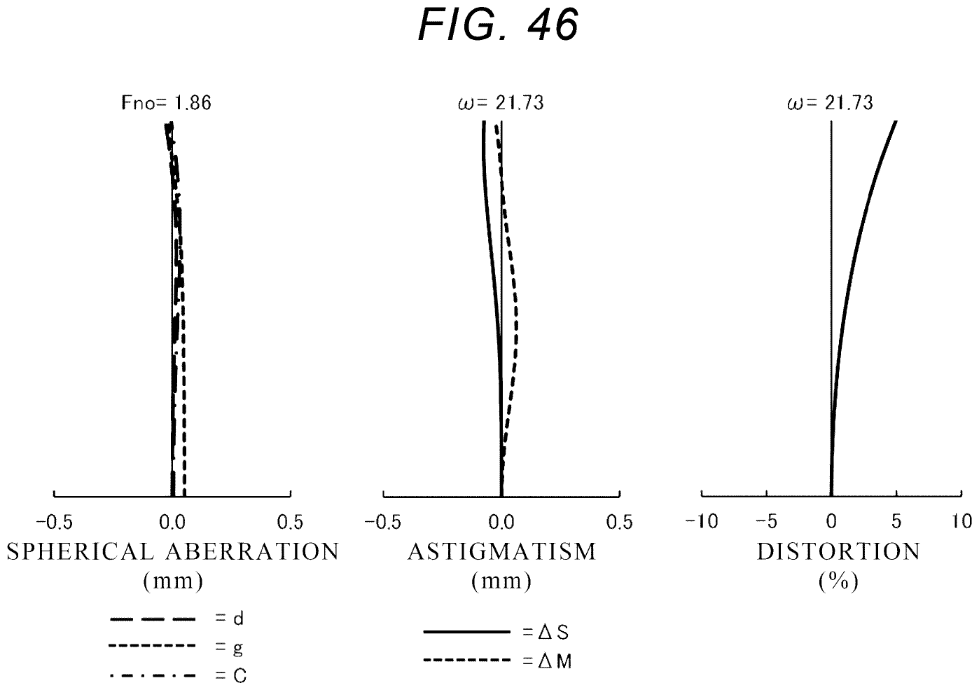

FIG. 47 is a lateral aberration diagram at the wide-angle end of the variable magnification optical system in Example 7 when focused at infinity.

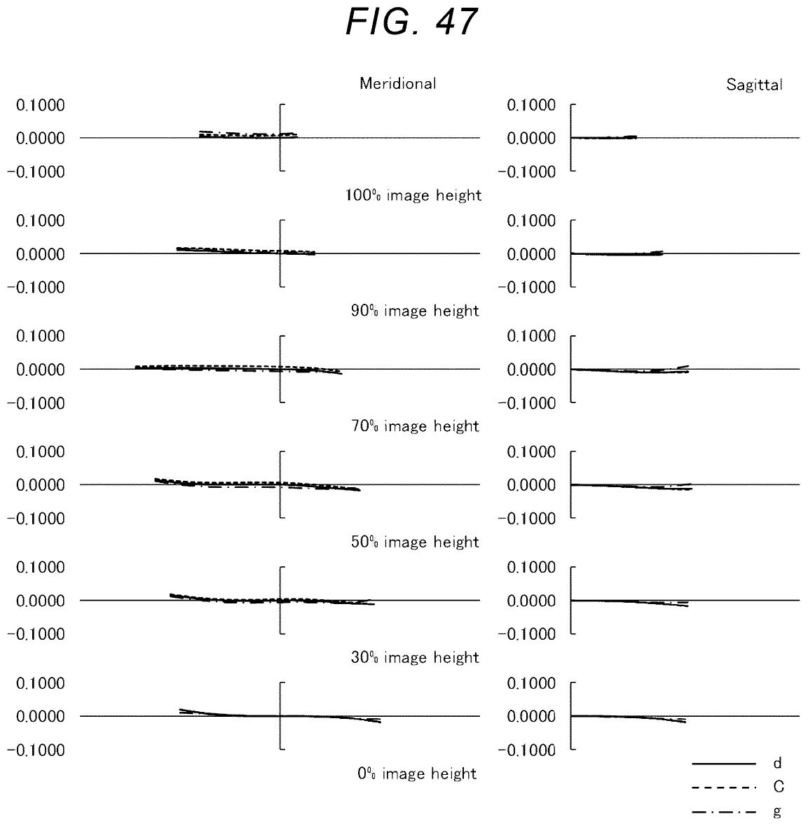

FIG. 48 is a lateral aberration diagram at the intermediate focal length in the variable magnification optical system of Example 7 when focused at infinity.

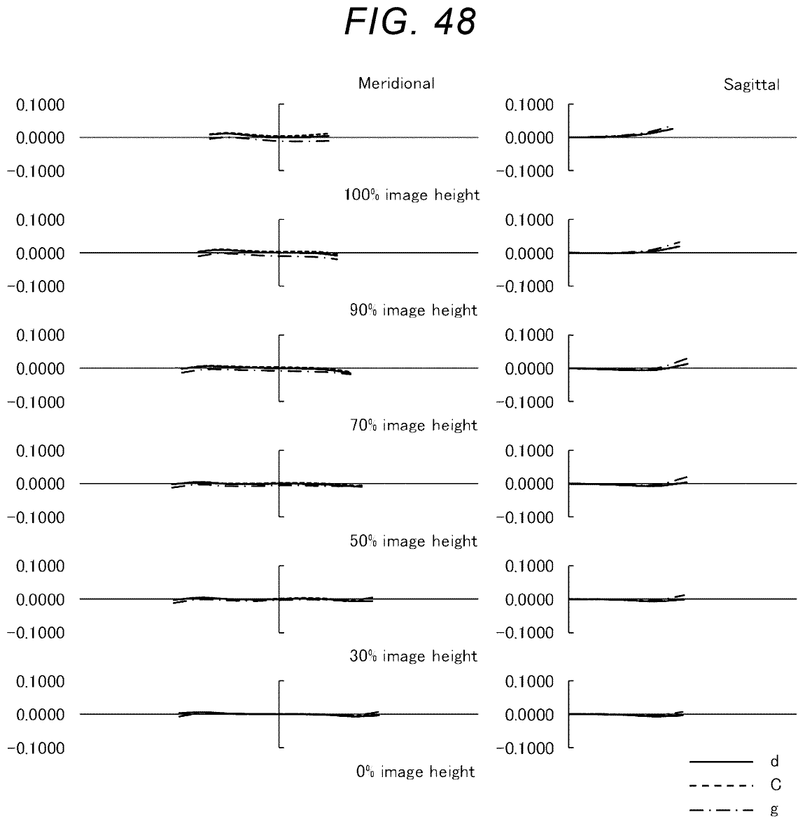

FIG. 49 is a lateral aberration diagram at the telephoto end of the variable magnification optical system in Example 7 when focused at infinity.

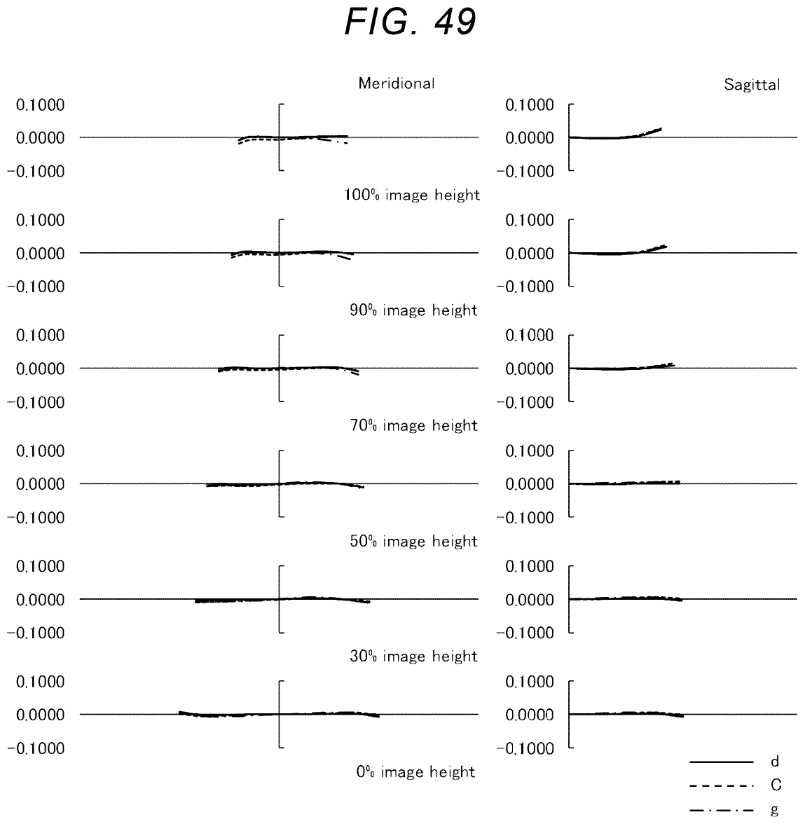

### DETAILED DESCRIPTION OF THE INVENTION

Hereinafter, examples of the optical system according to the present invention will be described in detail. The following description of the above-mentioned examples is a description of examples of the variable magnification optical system according to the embodiments of the present invention, and the present invention is not limited to the present examples within a range not departing from the gist of the present invention.

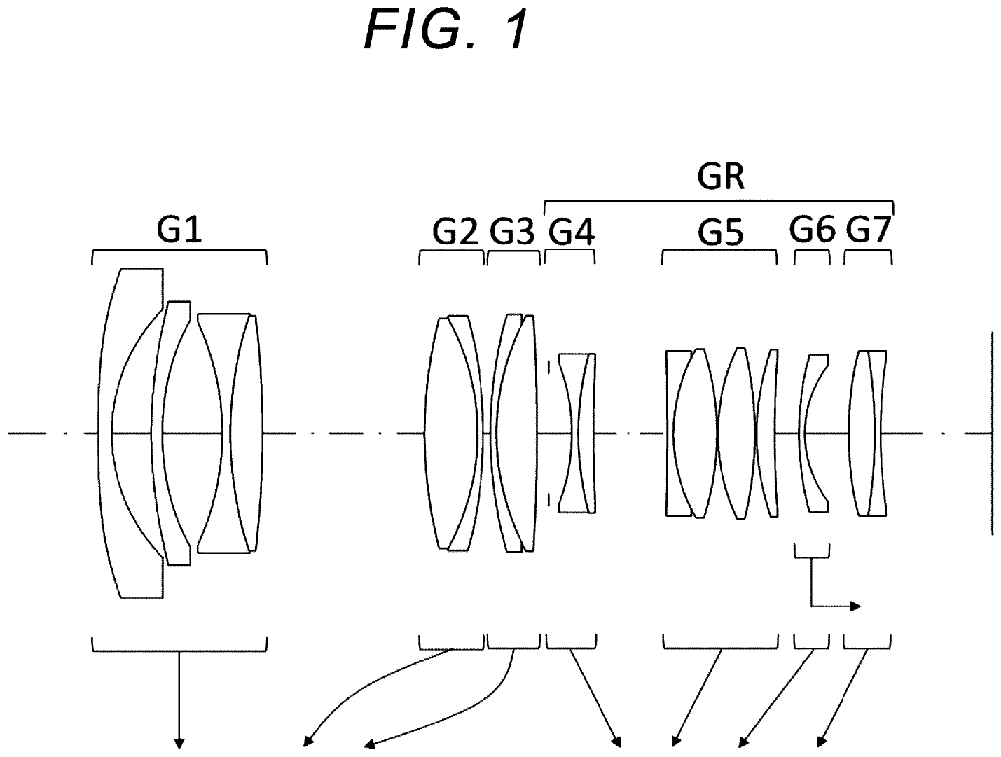

The variable magnification optical system of the present invention, as understood from the lens configuration diagrams shown in FIGS. 1, 8, 15, 22, 29, 36, and 43, consists of, in order from the object side, a first lens group G1 having a negative refractive power, a second lens group G2 having a positive refractive power, a third lens group G3 having a positive refractive power, and an image surface side lens group GR. During variable magnification from the wide-angle end to the telephoto end, the air distance between the first lens group G1 and the second lens group G2 decreases, the air distance between the second lens group G2 and the third lens group G3 changes, and the air distance between the third lens group G3 and the image surface side lens group GR increases.

The present invention aims to provide a variable magnification optical system that has a relatively large aperture ratio and is compact, while correcting various aberrations, including field curvature over the entire variable magnification range, and it is important to appropriately set the path of each lens group during variable magnification.

In a variable magnification optical system, a method is known in which a lens group having a negative refractive power, a lens group having a positive refractive power, and a lens group having a positive refractive power are arranged in order from the object side, and by varying the distance between the groups, the angle of view at the wide-angle end is kept wide while controlling field curvature in the intermediate variable magnification range. However, in the arrangement of groups as in the present invention, when the distance between the second lens group G2 and the third lens group G3 increases at the wide-angle end, the variable magnification function by the second lens group G2 is constrained. On the other hand, when the distance between the second lens group G2 and the third lens group G3 increases at the telephoto end, the variable magnification function by the third lens group G3 is constrained.

When the second lens group G2 and the third lens group G3 share the same path during variable magnification and are configured as a single lens group, the variable magnification function is not constrained, and it is possible to reduce the diameter of the marginal rays incident on the third lens group G3 and the image surface side lens group GR. However, it becomes necessary to move the first lens group G1 significantly along the optical axis to suppress variations in field curvature in the intermediate focal range during variable magnification. The first lens group G1 tends to have a relatively large lens diameter and a heavier lens barrel. Therefore, when the amount of movement due to variable magnification increases, the mechanism for holding the first lens group G1 also becomes larger, leading to an increase in the overall weight of the optical system. Additionally, since the first lens group G1 is in contact with the outside air on the object side, the strength and dustproof and drip-proof performance of the lens barrel may decrease when the lens barrel moves significantly.

Therefore, by setting the path such that the distance between the second lens group G2 and the third lens group G3 is minimized near the wide-angle end and the telephoto end, and increases at the intermediate variable magnification position, it becomes possible to suppress changes in field curvature while reducing the amount of movement of the first lens group G1, thereby achieving a compact and lightweight design.

The variable magnification optical system of the present invention further satisfies the following conditional expression:

$$- 0.08 < ( D 23 T - D 23 W ) / ( D 12 W - D 12 T ) < 0.08 ; \qquad ( 1 )$$

D12W: the distance between the first lens group G1 and the second lens group G2 at the wide-angle end
D12T: the distance between the first lens group G1 and the second lens group G2 at the telephoto end
D23W: the distance between the second lens group G2 and the third lens group at the wide-angle end
D23T: the distance between the second lens group G2 and the third lens group G3 at the telephoto end.

The conditional expression (1) specifies the preferred range for the ratio of the change in distance between the first lens group G1 and the second lens group G2, and the change in distance between the second lens group G2 and the third lens group G3, from the wide-angle end to the telephoto end.

When the distance between the second lens group G2 and the third lens group G3 at the wide-angle end increases and the value of the conditional expression (1) becomes lower than the lower limit, the variable magnification function provided by the second lens group G2 is constrained, making it difficult to ensure a sufficient variable magnification range.

When the upper limit value of the conditional expression (1) is exceeded and the distance between the second lens group G2 and the third lens group G3 at the telephoto end increases, the diameter of the marginal rays in the third lens group G3 and the image surface side lens group GR increases, making it difficult to downsize the lens barrel.

Additionally, by setting the lower limit value of the conditional expression (1) to −0.06, the effects of the present invention can be achieved more reliably. Additionally, by setting the upper limit value of the conditional expression (1) to 0.06, the effects of the present invention can be achieved more reliably.

The variable magnification optical system of the present invention further satisfies the following conditional expression:

$$0.08 < ( D 23 N - D 23 W ) / ( D 12 W - D 12 T ) < 0.4 ; \qquad ( 2 )$$

D23N: the distance between the second lens group G2 and the third lens group G3 at the intermediate variable magnification state
fw: the focal length of the entire lens system at the wide-angle end when focused at infinity
ft: the focal length of the entire lens system at the telephoto end when focused at infinity

Here, the intermediate variable magnification state refers to a state in which the focal length of the entire optical system, due to variable magnification, is equal to or near √(fw×ft).

The conditional expression (2) specifies a preferred range for the distance between the second lens group G2 and the third lens group G3 at the intermediate variable magnification state.

When the distance between the second lens group G2 and the third lens group G3 at the intermediate variable magnification state becomes narrower and the value of the conditional expression (2) becomes lower than the lower limit, it becomes difficult to suppress field curvature near this variable magnification range.

When the upper limit value of the conditional expression (2) is exceeded and the distance between the second lens group G2 and the third lens group G3 at the intermediate variable magnification state becomes wider, it becomes difficult to suppress lateral chromatic aberration near this zoom range.

Additionally, by setting the lower limit value of the conditional expression (2) to 0.10, the effects of the present invention can be achieved more reliably. Additionally, by setting the upper limit value of the conditional expression (2) to 0.35, the effects of the present invention can be achieved more reliably. Furthermore, to reliably achieve the effects of the present invention, it is preferable to set the upper limit value of the conditional expression (2) to 0.30.

The variable magnification optical system of the present invention further satisfies the following conditional expression:

$$0.08 < ( D 23 N - D 23 T ) / ( D 12 W - D 12 T ) < 0.4 ; \qquad ( 3 )$$

D23N: the distance between the second lens group G2 and the third lens group G3 at the intermediate variable magnification state
fw: the focal length of the entire lens system at the wide-angle end when focused at infinity
ft: the focal length of the entire lens system at the telephoto end when focused at infinity

Here, the intermediate variable magnification state refers to a state in which the focal length of the entire optical system, due to variable magnification, is approximately equal to or near √(fw×ft).

The conditional expression (3) specifies the preferred range for the distance between the second lens group G2 and the third lens group G3 at the intermediate variable magnification state.

When the distance between the second lens group G2 and the third lens group G3 at the intermediate variable magnification state becomes narrower and the value of the conditional expression (3) becomes lower than the lower limit, it becomes difficult to suppress spherical aberration near this variable magnification range.

When the upper limit value of the conditional expression (3) is exceeded and the distance between the second lens group G2 and the third lens group G3 at the intermediate variable magnification state becomes wider, not only does the spherical aberration become over-corrected near this variable magnification range, but it also becomes difficult to suppress the lateral chromatic aberration.

Additionally, by setting the lower limit value of the conditional expression (3) to 0.10, the effects of the present invention can be achieved more reliably. Additionally, by setting the upper limit value of the conditional expression (3) to 0.35, the effects of the present invention can be achieved more reliably. Furthermore, to reliably achieve the effects of the present invention, it is preferable to set the upper limit value of the conditional expression (3) to 0.30.

The variable magnification optical system of the present invention further satisfies the following conditional expression:

$$0.50 < ( D 34 T - D 34 W ) / ( D 12 W - D 12 T ) < 2. ; \qquad ( 4 )$$

D34W: the distance between the third lens group G3 and the image surface side lens group GR at the wide-angle end
D34T: the distance between the third lens group G3 and the image surface side lens group GR at the telephoto end.

The conditional expression (4) specifies the preferred range for the ratio of the change in distance between the first lens group G1 and the second lens group G2, and the change in distance between the third lens group G3 and the image surface side lens group GR, from the wide angle end to the telephoto end.

When the distance between the third lens group G3 and the image surface side lens group GR at the telephoto end becomes narrower and the value of the conditional expression (4) becomes lower than the lower limit, the variable magnification function provided by the third lens group G3 is constrained, making it difficult to ensure a sufficient variable magnification range.

When the upper limit value of the conditional expression (4) is exceeded and the distance between the third lens group G3 and the image surface side lens group GR at the telephoto end becomes wider, the diameter of the off-axis ray in the third lens group G3 and the group on its object side increases, making it difficult to downsize the lens barrel.

Additionally, by setting the lower limit value of the conditional expression (4) to 0.70, the effects of the present invention can be achieved more reliably. Furthermore, to reliably achieve the effects of the present invention, it is preferable to set the lower limit value of the conditional expression (4) to 0.90. Additionally, by setting the upper limit value of the conditional expression (4) to 1.80, the effects of the present invention can be achieved more reliably. Furthermore, to reliably achieve the effects of the present invention, it is preferable to set the upper limit value of the conditional expression (4) to 1.60.

Furthermore, it is preferable that the variable magnification optical system of the present invention satisfies the following conditional expressions:

$$- 0.04 < ( LTN - LTW ) / LTW < 0.06 ; and \qquad ( 5 )$$

$$- 0.06 < ( LTT - LTW ) / LTW < 0.08 ; \qquad ( 6 )$$

LTW: the total lens length at the wide-angle end
LTN: the total lens length at the intermediate variable magnification state
LTT: the total lens length at the telephoto end.

When the total lens length changes due to the variable magnification either lowering below the lower limit value or exceeding above the upper limit value of the conditional expression (5), it becomes difficult to ensure the strength and dustproof and drip-proof performance of the lens barrel.

When the total lens length changes due to the variable magnification, either lowering below the lower limit value or exceeding above the upper limit value of the conditional expression (6), it becomes difficult to ensure the strength and dustproof and drip-proof performance of the lens barrel.

Additionally, by setting the lower limit value of the conditional expression (5) to −0.02, the effects of the present invention can be achieved more reliably. Additionally, by setting the upper limit value of the conditional expression (5) to 0.03, the effects of the present invention can be achieved more reliably.

Additionally, by setting the lower limit value of the conditional expression (6) to −0.03, the effects of the present invention can be achieved more reliably. Additionally, by setting the upper limit value of the conditional expression (6) to 0.04, the effects of the present invention can be achieved more reliably.

In addition, it is preferable that the first lens group G1 remains fixed during variable magnification in the variable magnification optical system of the present invention.

By fixing the first lens group G1 during variable magnification, it becomes easier to ensure the strength and dustproof and drip-proof performance of the lens barrel.

Furthermore, in the variable magnification optical system of the present invention, it is preferable that the first lens group G1 includes at least one lens having a positive refractive power and at least two lenses each having a negative refractive power, and satisfies the following conditional expression:

$$0.20 < ndPG 1 - ndNG 1 < 0.45 ; \qquad ( 7 )$$

ndPG1: the mean value of the refractive indices at the d line wavelength of lenses having a positive refractive power arranged in the first lens group G1
ndNG1: the mean value of the refractive indices at the d line wavelength of lenses having a negative refractive power arranged in the first lens group G1.

When the difference in refractive indices between the lens having a positive refractive power and the lens having a negative refractive power in the first lens group G1 becomes smaller and the value of the conditional expression (7) becomes lower than the lower limit, it becomes difficult to suppress field curvature.

When the upper limit value of the conditional expression (7) is exceeded and the difference in refractive indices between the lens having a positive refractive power and the lens having a negative refractive power in the first lens group G1 becomes larger, the selection range of usable glass materials is limited, and it becomes difficult to maintain a wide angle of view at the wide-angle end while suppressing distortion.

Additionally, by setting the lower limit value of the conditional expression (7) to 0.25, the effects of the present invention can be achieved more reliably. Additionally, by setting the upper limit value of the conditional expression (7) to 0.40, the effects of the present invention can be achieved more reliably.

Furthermore, in the variable magnification optical system of the present invention, it is preferable that the second lens group G2 includes at least one lens having a positive refractive power and at least one lens having a negative refractive power, and satisfies the following conditional expression:

$$dPgPG 2 - dPgNG 2 > 0.01 ; \qquad ( 8 )$$

dPgPG2: the mean value of the deviation of the partial dispersion ratio with respect to the g line for lenses having a positive refractive power arranged in the second lens group G2
dPgNG2: the mean value of the deviation of the partial dispersion ratio with respect to the g line for lenses having a negative refractive power arranged in the second lens group G2.

Here, the deviation dPgF of the partial dispersion ratio with respect to the g line is calculated for each lens using the partial dispersion ratio θgF with respect to the g line and the Abbe number vd at the d line, as follows:

$$dPgF = θ gF - ( 0.648285 - 0.00180123 \times vd ) .$$

When the difference in partial dispersion ratio with respect to the g line between the lens having a positive refractive power and the lens having a negative refractive power in the second lens group G2 becomes smaller and the value of the conditional expression (8) becomes lower than the lower limit, it becomes difficult to suppress axial chromatic aberration and lateral chromatic aberration on the telephoto side.

Additionally, by setting the lower limit value of the conditional expression (8) to 0.015, the effects of the present invention can be more reliably achieved.

Furthermore, in the variable magnification optical system of the present invention, it is preferable that the image surface side lens group GR includes at least one lens having a positive refractive power and at least one lens having a negative refractive power, and satisfies the following conditional expression:

$$dPgPGR - dPgNGR > 0.01 ; \qquad ( 9 )$$

dPgPGR: the mean value of the deviation of the partial dispersion ratio with respect to the g line for lenses having a positive refractive power arranged in the image surface side lens group GR
dPgNGR: the mean value of the deviation of the partial dispersion ratio with respect to the g line for lenses having a negative refractive power arranged in the image surface side lens group GR.

Similar to the conditional expression (8), the deviation dPgF of the partial dispersion ratio with respect to the g line is calculated for each lens using the partial dispersion ratio θgF with respect to the g line and the Abbe number vd at the d line, as follows:

$$dPgF = θ gF - ( 0.648285 - 0.00180123 \times vd ) .$$

When the difference in partial dispersion ratio with respect to the g line between the lens having a positive refractive power and the lens having a negative refractive power in the image surface side lens group GR becomes smaller and the value of the conditional expression (9) become lower than the lower limit, it becomes difficult to suppress lateral chromatic aberration at the wide-angle end and axial chromatic aberration on the telephoto side.

Additionally, by setting the lower limit value of the conditional expression (9) to 0.015, the effects of the present invention can be achieved more reliably.

Furthermore, it is preferable that the variable magnification optical system of the present invention further satisfies the following conditional expressions:

$$- 0.6 < fw / f 1 < - 0.3 ; \qquad ( 10 )$$

$$0.2 < ft / f 2 < 0.6 ; and \qquad ( 11 )$$

$$0.4 < ft / f 3 < 0.8 ; \qquad ( 12 )$$

fw: the focal length of the entire lens system at the wide-angle end when focused at infinity
ft: the focal length of the entire lens system at the telephoto end when focused at infinity
f1: Focal length of the first lens group G1
f2: Focal length of the second lens group G2
f3: Focal length of the third lens group G3.

When the negative refractive power of the first lens group G1 becomes stronger and the value of the conditional expression (10) becomes lower than the lower limit, the marginal ray becomes thicker, making it difficult to reduce the diameter of the lenses in the second lens group G2 onward.

When the upper limit value of the conditional expression (10) is exceeded and the negative refractive power of the first lens group G1 becomes weaker, it becomes difficult to maintain a wide angle of view at the wide-angle end.

Additionally, by setting the lower limit value of the conditional expression (10) to −0.55, the effects of the present invention can be achieved more reliably. Additionally, by setting the upper limit value of the conditional expression (10) to −0.35, the effects of the present invention can be achieved more reliably.

When the positive refractive power of the second lens group G2 becomes weaker and the value of the conditional expression (11) becomes lower than the lower limit, the marginal ray becomes thicker, making it difficult to reduce the diameter of the lenses in the third lens group G3 onward.

When the upper limit value of conditional expression (11) is exceeded and the positive refractive power of the second lens group G2 becomes stronger, it becomes difficult to select glass materials for the lenses within the second lens group G2 that satisfy the conditional expression (8) while suppressing spherical aberration and coma aberration.

Additionally, by setting the lower limit value of the conditional expression (11) to 0.25, the effects of the present invention can be achieved more reliably. Additionally, by setting the upper limit value of the conditional expression (11) to 0.55, the effects of the present invention can be achieved more reliably.

When the positive refractive power of the third lens group G3 becomes weaker and the value of the conditional expression (12) becomes lower than the lower limit, it becomes difficult to sufficiently ensure the variable magnification function from the wide angle end to the telephoto end.

When the upper limit value of conditional expression (12) is exceeded and the positive refractive power of the third lens group G3 becomes stronger, it becomes difficult to suppress spherical aberration and coma aberration.

Additionally, by setting the lower limit value of the conditional expression (12) to 0.45, the effects of the present invention can be achieved more reliably. Additionally, by setting the upper limit value of the conditional expression (12) to 0.75, the effects of the present invention can be achieved more reliably.

Furthermore, it is preferable that the image surface side lens group GR in the variable magnification optical system of the present invention consists of, in order from the object side, a fourth lens group G4 having a negative refractive power and a fifth lens group G5 having a positive refractive power.

By arranging in this manner, it becomes possible to appropriately control the variations in spherical aberration and astigmatism.

Furthermore, it is preferable that the variable magnification optical system of the present invention further satisfies the following conditional expression:

$$- 1.4 < ft / f 4 < - 0.7 ; \qquad ( 13 )$$

f4: focal length of the fourth lens group G4.

When the negative refractive power of the fourth lens group G4 becomes stronger and the value of the conditional expression (13) becomes lower than the lower limit, the marginal ray becomes thicker, making it difficult to reduce the diameter of the lenses from the fifth lens group G5 onward.

When the upper limit value of the conditional expression (13) is exceeded and the negative refractive power of the fourth lens group G4 becomes weaker, it becomes difficult to suppress the variation in spherical aberration.

Additionally, by setting the lower limit value of the conditional expression (13) to −1.30, the effects of the present invention can be achieved more reliably. Additionally, by setting the upper limit value of the conditional expression (13) to −0.80, the effects of the present invention can be achieved more reliably.

Furthermore, it is preferable that the variable magnification optical system of the present invention further satisfies the following conditional expression:

$$1.75 < ft / fw < 3.50 . \qquad ( 14 )$$

When the zoom ratio of the optical system becomes smaller and the value of the conditional expression (14) becomes lower than the lower limit, it becomes difficult to achieve usability as a variable magnification optical system. When the upper limit value of the conditional expression (14) is exceeded and the zoom ratio of the optical system increases, it becomes difficult to achieve downsizing while maintaining high imaging performance.

Additionally, by setting the lower limit value of the conditional expression (14) to 2.00, the effects of the present invention can be achieved more reliably. Additionally, by setting the upper limit value of the conditional expression (14) to 3.00, the effects of the present invention can be achieved more reliably.

Furthermore, it is preferable that the variable magnification optical system of the present invention further satisfies the following conditional expression:

$$1. 40 ≦ Fnot ≦ 2.8 ; \qquad ( 15 )$$

Fnot: F number of the entire lens system at the telephoto end when focused at infinity.

When the F number of the optical system becomes smaller and the value of the conditional expression (15) becomes lower than the lower limit, it becomes difficult to achieve downsizing while maintaining high imaging performance. When the upper limit value of the conditional expression (15) is exceeded and the F number becomes larger, it becomes difficult to perform photography that makes use of more pronounced bokeh or to take photographs at shorter shutter speeds in low-light conditions.

Additionally, by setting the lower limit value of the conditional expression (15) to 1.60, the effects of the present invention can be more reliably achieved. Additionally, by setting the upper limit value of the conditional expression (15) to 2.40, the effects of the present invention can be achieved more reliably.

Next, the lens configuration, numerical examples, and conditional expression corresponding values of the variable magnification optical system according to an embodiment of the present invention will be described. In the following description, the lens configuration will be described in order from the object side to the image surface side.

In [Surface data], the surface number is a number of a lens surface or an aperture diaphragm counted from the object side, r is a curvature radius of each lens surface, d is a distance between the lens surfaces, nd is a refractive index with respect to the d line (wavelength of 587.56 nm), vd is an Abbe number with respect to the d line, and θgF indicates a partial dispersion ratio of the g line (wavelength of 435.84 nm) and the F line (wavelength of 486.13 nm).

An asterisk (*) attached to a surface number indicates that the lens surface shape is an aspherical surface shape. In addition, BF represents a back focus.

The (diaphragm) attached to the surface number indicates that the aperture diaphragm is located at that position. In a case of a curvature radius with respect to a plane or an aperture diaphragm, ∞ (infinity) is written.

[Aspherical surface data] shows values of each coefficient for giving the aspherical shape of the lens surface denoted by * in [Surface data]. The shape of the aspherical surface is expressed by the following equation. In the following equation, the displacement from the optical axis in the direction perpendicular to the optical axis is represented by y, the displacement (sag) from the intersection of the aspherical surface and the optical axis in the optical axis direction is represented by z, the curvature radius of the reference spherical surface is represented by r, and the conic constant is represented by K. Additionally, when aspherical coefficients of the 4th, 6th, 8th, 10th, 12th, and 14th order are denoted as A4, A6, A8, A10, A12, and A14 respectively, the coordinates of the aspherical surface are assumed by the following equation.

$$z = \frac{( 1 / r ) {y}^{2}}{1 + \sqrt{1 - ( 1 + K ) {( y / r )}^{2}}} + A 4 {y}^{4} + A 6 {y}^{6} + A 8 {y}^{8} + A 10 {y}^{10} + A 12 {y}^{12} + A 14 {y}^{14}$$

[Various types of data] indicate values such as a zoom ratio and a focal length in each focal length state.

The [Variable Distance Data] shows the variable distance and the BF value in each focal length state.

The [Lens group data] shows the surface number closest to the object side in each lens group and the total focal length of the entire group.

In addition, in the aberration diagrams corresponding to the respective examples, d, g, and C represent a d line, a g line, and a C line, respectively, and ΔS and ΔM represent a sagittal image surface and a meridional image surface, respectively.

In addition, in all the values of the specifications described below, unless otherwise noted, the units of the focal length f, the curvature radius r, the lens surface distance d, and other lengths are millimeters (mm), but the present invention is not limited thereto since the same optical performance can be obtained in both the proportional magnification and the proportional reduction in the optical system.

### Example 1

FIG. 1 is a configuration diagram of the optical system in Example 1 of the present invention.

The optical system of Example 1 consists of, in order from the object side, a first lens group G1 having a negative refractive power, a second lens group G2 having a positive refractive power, a third lens group G3 having a positive refractive power, and an image surface side lens group GR. The image surface side lens group GR consists of, in order from the object side, a fourth lens group G4 having a negative refractive power, a fifth lens group G5 having a positive refractive power, a sixth lens group G6 having a negative refractive power, and a seventh lens group G7 having a positive refractive power. An aperture diaphragm S is arranged between the third lens group G3 and the fourth lens group G4, and during variation magnification, the aperture diaphragm S moves integrally with the fourth lens group G4.

The first lens group G1 consists of, in order from the object side, a negative meniscus lens with a convex surface having a predetermined aspherical shape facing the object side, a negative meniscus lens with both surfaces having predetermined aspherical shapes and a convex surface facing the object side, and a cemented lens consisting of a biconcave lens and a biconvex lens.

The second lens group G2 consists of a cemented lens consisting of a biconvex lens and a negative meniscus lens with a convex surface facing the image surface side.

The third lens group G3 consists of a cemented lens consisting of, in order from the object side, a negative meniscus lens with a convex surface facing the object side and a biconvex lens.

The fourth lens group G4 consists of a cemented lens consisting of a biconcave lens and a positive meniscus lens with a convex surface facing the object side.

The fifth lens group G5 consists of, in order from the object side, a cemented lens consisting of a biconcave lens and a biconvex lens, a biconvex lens, and a positive meniscus lens with both surfaces having predetermined aspherical shapes and a convex surface facing the object side.

The sixth lens group G6 consists of a negative meniscus lens with a convex surface facing the object side. The whole sixth lens group G6 moves toward the image surface side during focusing from an infinite object distance to a close distance.

The seventh lens group G7 consists of a cemented lens consisting of a biconvex lens with a surface on the object side having a predetermined aspherical shape and a biconcave lens.

In Example 1, the variable magnification optical system experiences the following changes during variable magnification from the wide-angle end to the telephoto end: the distance between the first lens group G1 and the second lens group G2 decreases; the distance between the second lens group G2 and the third lens group G3 first increases and then decreases; the distance between the third lens group G3 and the fourth lens group G4 increases; the distance between the fourth lens group G4 and the fifth lens group G5 decreases; the distance between the fifth lens group G5 and the sixth lens group G6 decreases; the distance between the sixth lens group G6 and the seventh lens group G7 increases; and the distance between the seventh lens group G7 and the image surface increases.

Additionally, in the variable magnification optical system of Example 1, during variable magnification from the wide-angle end to the telephoto end, the first lens group G1 remains fixed relative to the image surface, while the second lens group G2 to the seventh lens group G7 each moves relative to the image surface.

Subsequently, the specifications of the optical system according to Example 1 are shown below.

Numerical Example 1
Unit: mm
[Surface data]

| Surface number | r | d | nd | νd | θgF |
|---|---|---|---|---|---|
| Object surface | ∞ | (d0) | | | |
| 1* | 250.0000 | 2.0027 | 1.59271 | 66.97 | 0.5367 |
| 2 | 27.8483 | 5.9106 | | | |
| 3* | 75.5339 | 1.7000 | 1.55352 | 71.72 | 0.5398 |
| 4* | 43.9336 | 8.9578 | | | |
| 5 | −42.5013 | 1.2000 | 1.48749 | 70.44 | 0.5306 |
| 6 | 59.3792 | 4.8124 | 1.85033 | 42.70 | 0.5646 |
| 7 | −158.0782 | (d7) | | | |
| 8 | 73.9893 | 7.8404 | 1.55032 | 75.50 | 0.5401 |
| 9 | −38.4074 | 0.9000 | 1.77047 | 29.74 | 0.5951 |
| 10 | −71.2235 | (d10) | | | |
| 11 | 69.5442 | 0.9000 | 1.75211 | 25.05 | 0.6192 |
| 12 | 39.4005 | 6.0497 | 1.75500 | 52.32 | 0.5473 |
| 13 | −303.0102 | (d13) | | | |
| 14(diaphragm) | ∞ | 3.4674 | | | |
| 15 | −31.4322 | 0.9500 | 1.78590 | 43.94 | 0.5612 |
| 16 | 49.4614 | 2.2536 | 1.98612 | 16.48 | 0.6656 |
| 17 | 258.2249 | (d17) | | | |
| 18 | −410.5686 | 0.9000 | 1.73037 | 32.23 | 0.5899 |
| 19 | 26.6348 | 6.4880 | 1.59282 | 68.62 | 0.5440 |
| 20 | −44.4800 | 0.1500 | | | |
| 21 | 31.2840 | 5.5107 | 1.59282 | 68.62 | 0.5440 |
| 22 | −57.9617 | 0.2500 | | | |
| 23* | 35.7978 | 2.7669 | 1.59271 | 66.97 | 0.5367 |
| 24* | 234.5415 | (d24) | | | |
| 25 | 46.4631 | 0.9000 | 1.74330 | 49.22 | 0.5495 |
| 26 | 17.9200 | (d26) | | | |
| 27* | 60.4900 | 3.8719 | 1.80610 | 40.73 | 0.5694 |
| 28 | −80.4564 | 0.9000 | 1.85451 | 25.15 | 0.6103 |
| 29 | 80.4564 | (BF) | | | |
| Image surface | ∞ | | | | |

| [Aspherical surface data] | | | | | | |
|---|---|---|---|---|---|---|
| | Surface 1 | Surface 3 | Surface 4 | Surface 23 | Surface 24 | Surface 27 |
| K | 0.00000 | 0.00000 | 0.00000 | 0.00000 | 0.00000 | 0.00000 |
| A4 | 8.81137E−06 | −2.07372E−06 | 6.10616E−06 | −8.60792E−06 | 3.85958E−06 | 1.05308E−06 |
| A6 | −9.35247E−09 | 7.46142E−09 | 6.61601E−09 | 1.99952E−09 | 1.95216E−08 | 5.18117E−08 |
| A8 | 3.56200E−12 | −1.62322E−11 | −4.17607E−11 | −4.94951E−11 | −7.83598E−11 | −4.36191E−10 |
| A10 | 9.76737E−15 | 9.72804E−15 | 5.07229E−14 | −7.59311E−14 | 1.91464E−13 | 2.64638E−12 |
| A12 | −1.41083E−17 | 0.00000E+00 | 0.00000E+00 | 5.27607E−16 | 0.00000E+00 | −5.67644E−15 |
| A14 | 6.28920E−21 | 0.00000E+00 | 0.00000E+00 | 0.00000E+00 | 0.00000E+00 | 0.00000E+00 |

[Various types of data]
Zoom ratio 2.21

| | Wide angle | Middle | Telephoto |
|---|---|---|---|
| Focal length | 17.55 | 26.06 | 38.70 |
| F number | 1.86 | 1.86 | 1.86 |
| Total angle of view 2ω | 83.28 | 56.14 | 38.54 |
| Image height Y | 14.20 | 14.20 | 14.20 |
| Total lens length | 133.60 | 133.60 | 133.60 |

[Variable distance data]

| | Wide angle | Middle | Telephoto |
|---|---|---|---|
| d0 | ∞ | ∞ | ∞ |
| d7 | 24.2001 | 10.3101 | 1.3704 |
| d10 | 1.0967 | 4.7167 | 1.0966 |
| d13 | 1.7600 | 13.8950 | 29.4811 |
| d17 | 11.0343 | 7.0293 | 1.6434 |
| d24 | 3.5756 | 2.6096 | 1.6000 |
| d26 | 6.5786 | 7.5446 | 8.5541 |
| BF | 16.6727 | 18.8127 | 21.1723 |

[Lens group data]

| Group | Starting surface | Focal length |
|---|---|---|
| G1 | 1 | −41.68 |
| G2 | 8 | 81.16 |
| G3 | 11 | 75.35 |
| G4 | 14 | −40.22 |
| G5 | 18 | 20.37 |
| G6 | 25 | −39.78 |
| G7 | 27 | 401.59 |

### Example 2

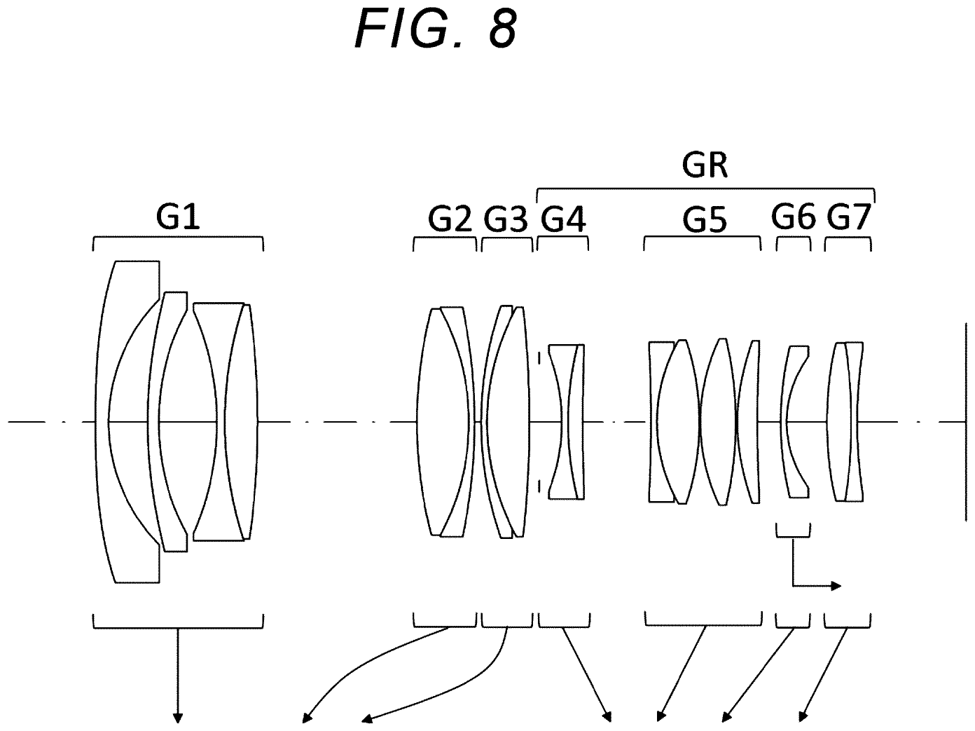

FIG. 8 is a configuration diagram of the optical system in Example 2 of the present invention.

The optical system of Example 2 consists of, in order from the object side, a first lens group G1 having a negative refractive power, a second lens group G2 having a positive refractive power, a third lens group G3 having a positive refractive power, and an image surface side lens group GR. The image surface side lens group GR consists of, in order from the object side, a fourth lens group G4 having a negative refractive power, a fifth lens group G5 having a positive refractive power, a sixth lens group G6 having a negative refractive power, and a seventh lens group G7 having a positive refractive power. An aperture diaphragm S is arranged between the third lens group G3 and the fourth lens group G4, and during variation magnification, the aperture diaphragm S moves integrally with the fourth lens group G4.

The first lens group G1 consists of, in order from the object side, a negative meniscus lens with a convex surface having a predetermined aspherical shape facing the object side, a negative meniscus lens with both surfaces having predetermined aspherical shapes and a convex surface facing the object side, and a cemented lens consisting of a biconcave lens and a biconvex lens.

The second lens group G2 consists of a cemented lens consisting of a biconvex lens and a negative meniscus lens with a convex surface facing the image surface side.

The third lens group G3 consists of a cemented lens consisting of, in order from the object side, a negative meniscus lens with a convex surface facing the object side and a biconvex lens.

The fourth lens group G4 consists of a cemented lens consisting of a biconcave lens and a positive meniscus lens with a convex surface facing the object side.

The fifth lens group G5 consists of, in order from the object side, a cemented lens consisting of a biconcave lens and a biconvex lens, a biconvex lens, and a positive meniscus lens with both surfaces having predetermined aspherical shapes and a convex surface facing the object side.

The sixth lens group G6 consists of a negative meniscus lens with a convex surface facing the object side. The whole sixth lens group G6 moves toward the image surface side during focusing from an infinite object distance to a close distance.

The seventh lens group G7 consists of a cemented lens consisting of a biconvex lens with a surface on the object side having a predetermined aspherical shape and a biconcave lens.

In Example 2, the variable magnification optical system experiences the following changes during variable magnification from the wide angle end to the telephoto end: the distance between the first lens group G1 and the second lens group G2 decreases; the distance between the second lens group G2 and the third lens group G3 first increases and then decreases; the distance between the third lens group G3 and the fourth lens group G4 increases; the distance between the fourth lens group G4 and the fifth lens group G5 decreases; the distance between the fifth lens group G5 and the sixth lens group G6 decreases; the distance between the sixth lens group G6 and the seventh lens group G7 increases; and the distance between the seventh lens group G7 and the image surface increases.

Additionally, in the variable magnification optical system of Example 2, during variable magnification from the wide-angle end to the telephoto end, the first lens group G1 remains fixed relative to the image surface, while the second lens group G2 to the seventh lens group G7 each moves relative to the image surface.

Subsequently, the specifications of the optical system according to Example 2 are shown below.

Numerical Example 2
Unit: mm
[Surface data]

| Surface number | r | d | nd | νd | θgF |
|---|---|---|---|---|---|
| Object surface | ∞ | (d0) | | | |
| 1* | 250.0000 | 2.0000 | 1.59271 | 66.97 | 0.5367 |
| 2 | 28.0986 | 5.9974 | | | |
| 3* | 79.6790 | 1.7000 | 1.55352 | 71.72 | 0.5398 |
| 4* | 42.3231 | 8.9421 | | | |
| 5 | −44.2746 | 1.2000 | 1.48749 | 70.44 | 0.5306 |
| 6 | 62.2565 | 5.0259 | 1.85033 | 42.70 | 0.5646 |
| 7 | −132.4181 | (d7) | | | |
| 8 | 71.3997 | 7.9567 | 1.57144 | 71.61 | 0.5419 |
| 9 | −38.7392 | 0.9000 | 1.73037 | 32.23 | 0.5899 |
| 10 | −88.3123 | (d10) | | | |
| 11 | 57.1124 | 0.9000 | 1.68430 | 26.81 | 0.6232 |
| 12 | 38.5040 | 6.5166 | 1.59282 | 68.62 | 0.5440 |
| 13 | −169.7744 | (d13) | | | |
| 14(diaphragm) | ∞ | 3.4915 | | | |
| 15 | −30.7261 | 0.9500 | 1.78590 | 43.94 | 0.5612 |
| 16 | 52.1805 | 2.2231 | 1.98612 | 16.48 | 0.6656 |
| 17 | 317.2241 | (d17) | | | |
| 18 | −250.4292 | 0.9000 | 1.73037 | 32.23 | 0.5899 |
| 19 | 26.9764 | 6.5142 | 1.59282 | 68.62 | 0.5440 |
| 20 | −41.9747 | 0.1500 | | | |
| 21 | 31.3561 | 5.4603 | 1.59282 | 68.62 | 0.5440 |
| 22 | −58.8165 | 0.2500 | | | |
| 23* | 33.3228 | 3.0755 | 1.59271 | 66.97 | 0.5367 |
| 24* | 321.7339 | (d24) | | | |
| 25 | 52.1821 | 0.9000 | 1.74330 | 49.22 | 0.5495 |
| 26 | 17.7596 | (d26) | | | |
| 27* | 63.5310 | 3.7356 | 1.77250 | 49.50 | 0.5519 |
| 28 | −78.8320 | 0.9000 | 1.77047 | 29.74 | 0.5951 |
| 29 | 78.8320 | (BF) | | | |
| Image surface | ∞ | | | | |

| [Aspherical surface data] | | | | | | |
|---|---|---|---|---|---|---|
| | Surface 1 | Surface 3 | Surface 4 | Surface 23 | Surface 24 | Surface 27 |
| K | 0.00000 | 0.00000 | 0.00000 | 0.00000 | 0.00000 | 0.00000 |
| A4 | 7.26691E−06 | −6.24828E−07 | 5.81787E−06 | −8.59838E−06 | 3.80591E−06 | 5.05265E−07 |
| A6 | −7.22521E−09 | 6.26382E−09 | 5.39580E−09 | −1.12781E−08 | 2.43011E−09 | 5.94289E−08 |
| A8 | −4.06461E−13 | −2.14124E−11 | −4.71268E−11 | −1.16085E−11 | −2.25411E−12 | −5.47652E−10 |
| A10 | 1.61641E−14 | 1.59496E−14 | 5.37658E−14 | −1.18479E−13 | 8.99556E−14 | 3.60505E−12 |
| A12 | −2.07944E−17 | 0.00000E+00 | 0.00000E+00 | 6.31297E−16 | 0.00000E+00 | −8.28823E−15 |
| A14 | 9.19755E−21 | 0.00000E+00 | 0.00000E+00 | 0.00000E+00 | 0.00000E+00 | 0.00000E+00 |

[Various types of data]
Zoom ratio 2.21

| | Wide angle | Middle | Telephoto |
|---|---|---|---|
| Focal length | 17.55 | 26.06 | 38.70 |
| F number | 1.86 | 1.86 | 1.86 |
| Total angle of view 2ω | 83.27 | 56.11 | 38.54 |
| Image height Y | 14.20 | 14.20 | 14.20 |
| Total lens length | 133.60 | 133.60 | 133.60 |

[Various types of data]

| | Wide angle | Middle | Telephoto |
|---|---|---|---|
| d0 | ∞ | ∞ | ∞ |
| d7 | 24.4525 | 10.1532 | 1.2336 |
| d10 | 1.0107 | 4.7033 | 1.0000 |
| d13 | 1.5000 | 14.5085 | 29.5150 |
| d17 | 10.4987 | 6.5321 | 1.2531 |
| d24 | 3.5725 | 2.8431 | 1.6000 |
| d26 | 6.2091 | 6.9385 | 8.1816 |
| BF | 16.6677 | 18.2325 | 21.1280 |

[Lens group data]

| Group | Starting surface | Focal length |
|---|---|---|
| G1 | 1 | −43.52 |
| G2 | 8 | 83.44 |
| G3 | 11 | 77.20 |
| G4 | 14 | −40.14 |
| G5 | 18 | 19.71 |
| G6 | 25 | −36.63 |
| G7 | 27 | 367.38 |

### Example 3

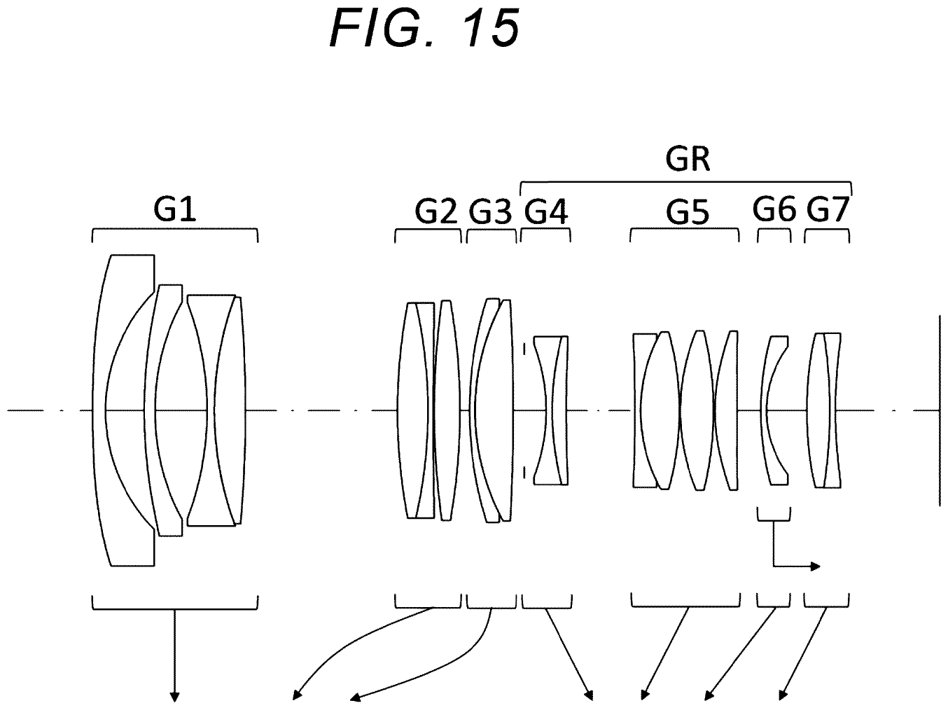

FIG. 15 is a configuration diagram of the optical system in Example 3 of the present invention.

The optical system of Example 3 consists of, in order from the object side, a first lens group G1 having a negative refractive power, a second lens group G2 having a positive refractive power, a third lens group G3 having a positive refractive power, and an image surface side lens group GR. The image surface side lens group GR consists of, in order from the object side, a fourth lens group G4 having a negative refractive power, a fifth lens group G5 having a positive refractive power, a sixth lens group G6 having a negative refractive power, and a seventh lens group G7 having a positive refractive power. An aperture diaphragm S is arranged between the third lens group G3 and the fourth lens group G4, and during variation magnification, the aperture diaphragm S moves integrally with the fourth lens group G4.

The first lens group G1 consists of, in order from the object side, a negative meniscus lens having a predetermined aspherical shape with a convex surface facing the object side, a negative meniscus lens with both surfaces having predetermined aspherical shapes and a convex surface facing the object side, and a cemented lens consisting of a biconcave lens and a biconvex lens.

The second lens group G2 consists of a cemented lens consisting of a biconvex lens and a biconcave lens, and a biconvex lens.

The third lens group G3 consists of a cemented lens consisting of, in order from the object side, a negative meniscus lens with a convex surface facing the object side and a biconvex lens.

The fourth lens group G4 consists of a cemented lens consisting of a biconcave lens and a positive meniscus lens with a convex surface facing the object side.

The fifth lens group G5 consists of, in order from the object side, a cemented lens consisting of a biconcave lens and a biconvex lens, a biconvex lens, and a biconvex lens with both surfaces having predetermined aspherical shapes and a convex surface facing the object side.

The sixth lens group G6 consists of a negative meniscus lens with a convex surface facing the object side. The whole sixth lens group G6 moves toward the image surface side during focusing from an infinite object distance to a close distance.

The seventh lens group G7 consists of a cemented lens consisting of a biconvex lens with a surface on the object side having a predetermined aspherical shape and a biconcave lens.

In Example 3, the variable magnification optical system experiences the following changes during variable magnification from the wide angle end to the telephoto end: the distance between the first lens group G1 and the second lens group G2 decreases; the distance between the second lens group G2 and the third lens group G3 first increases and then decreases; the distance between the third lens group G3 and the fourth lens group G4 increases; the distance between the fourth lens group G4 and the fifth lens group G5 decreases; the distance between the fifth lens group G5 and the sixth lens group G6 decreases; the distance between the sixth lens group G6 and the seventh lens group G7 increases; and the distance between the seventh lens group G7 and the image surface increases.

Additionally, in the variable magnification optical system of Example 3, during variable magnification from the wide-angle end to the telephoto end, the first lens group G1 remains fixed relative to the image surface, while the second lens group G2 to the seventh lens group G7 each moves relative to the image surface.

Subsequently, the specifications of the optical system according to Example 3 are shown below.

Numerical Example 3
Unit: mm
[Surface data]

| Surface number | r | d | nd | νd | θgF |
|---|---|---|---|---|---|
| Object surface | ∞ | (d0) | | | |
| 1* | 250.0000 | 2.0024 | 1.59271 | 66.97 | 0.5367 |
| 2 | 28.3681 | 6.1839 | | | |
| 3* | 88.8389 | 1.7000 | 1.55352 | 71.72 | 0.5398 |
| 4* | 42.9753 | 8.2631 | | | |
| 5 | −51.9299 | 1.2000 | 1.48749 | 70.44 | 0.5306 |
| 6 | 55.8392 | 4.9041 | 1.88300 | 40.81 | 0.5656 |
| 7 | −218.7120 | (d7) | | | |
| 8 | 97.0199 | 4.8364 | 1.55032 | 75.50 | 0.5401 |
| 9 | −81.1509 | 0.9000 | 1.77047 | 29.74 | 0.5951 |
| 10 | 1096.3011 | 0.1500 | | | |
| 11 | 135.4524 | 4.0554 | 1.55032 | 75.50 | 0.5401 |
| 12 | −107.0918 | (d12) | | | |
| 13 | 62.5660 | 0.9000 | 1.80809 | 22.76 | 0.6287 |
| 14 | 39.1804 | 6.0244 | 1.75500 | 52.32 | 0.5473 |
| 15 | −339.3229 | (d15) | | | |
| 16(diaphragm) | ∞ | 3.4363 | | | |
| 17 | −31.4738 | 0.9500 | 1.78590 | 43.94 | 0.5612 |
| 18 | 48.3598 | 2.2714 | 1.98612 | 16.48 | 0.6656 |
| 19 | 262.8369 | (d19) | | | |
| 20 | −279.2338 | 0.9000 | 1.73037 | 32.23 | 0.5899 |
| 21 | 27.1590 | 6.1753 | 1.59282 | 68.62 | 0.5440 |
| 22 | −49.3988 | 0.1500 | | | |
| 23 | 34.7926 | 5.2807 | 1.59282 | 68.62 | 0.5440 |
| 24 | −56.4441 | 0.2500 | | | |
| 25* | 33.2854 | 3.5428 | 1.59271 | 66.97 | 0.5367 |
| 26* | −1419.9085 | (d26) | | | |
| 27 | 47.6860 | 0.9000 | 1.74330 | 49.22 | 0.5495 |
| 28 | 17.8501 | (d28) | | | |
| 29* | 64.2381 | 3.6815 | 1.82080 | 42.71 | 0.5643 |
| 30 | −84.0859 | 0.9000 | 1.85451 | 25.15 | 0.6103 |
| 31 | 84.0859 | (BF) | | | |
| Image surface | ∞ | | | | |

[Aspherical surface data]

| | Surface 1 | Surface 3 | Surface 4 | Surface 25 | Surface 26 | Surface 29 |
|---|---|---|---|---|---|---|
| K | 0.00000 | 0.00000 | 0.00000 | 0.00000 | 0.00000 | 0.00000 |
| A4 | 6.31297E−06 | 6.53481E−07 | 6.33956E−06 | −8.05304E−06 | 3.80378E−06 | 4.41208E−07 |
| A6 | −5.83453E−09 | 1.44395E−09 | 7.47935E−10 | −5.73130E−09 | 2.90012E−09 | 4.71040E−08 |
| A8 | −1.74364E−12 | −1.40687E−11 | −3.75063E−11 | −7.77939E−11 | −6.34632E−11 | −3.91613E−10 |
| A10 | 1.68817E−14 | 1.22544E−14 | 4.94385E−14 | 1.71745E−13 | 2.45809E−13 | 2.51575E−12 |
| A12 | −2.09273E−17 | 0.00000E+00 | 0.00000E+00 | 2.07293E−16 | 0.00000E+00 | −5.53043E−15 |
| A14 | 9.13022E−21 | 0.00000E+00 | 0.00000E+00 | 0.00000E+00 | 0.00000E+00 | 0.00000E+00 |

[Various types of data]
Zoom ratio 2.21

| | Wide angle | Middle | Telephoto |
|---|---|---|---|
| Focal length | 17.55 | 26.06 | 38.70 |
| F number | 1.86 | 1.86 | 1.86 |
| Total angle of view 2ω | 83.28 | 56.19 | 38.54 |
| Image height Y | 14.20 | 14.20 | 14.20 |
| Total lens length | 134.80 | 134.80 | 134.80 |

[Variable distance data]

| | Wide angle | Middle | Telephoto |
|---|---|---|---|
| d0 | ∞ | ∞ | ∞ |
| d7 | 24.2268 | 10.2456 | 1.2000 |
| d12 | 1.5368 | 4.8568 | 1.5401 |
| d15 | 1.8159 | 14.5431 | 30.0459 |
| d19 | 10.8884 | 6.8733 | 1.3666 |
| d26 | 3.7287 | 2.7156 | 1.6000 |
| d28 | 6.4191 | 7.4321 | 8.5478 |
| BF | 16.6266 | 18.5758 | 20.9419 |

[Lens group data]

| Group | Starting surface | Focal length |
|---|---|---|
| G1 | 1 | −43.40 |
| G2 | 8 | 88.85 |
| G3 | 13 | 73.04 |
| G4 | 16 | −40.54 |
| G5 | 20 | 20.19 |
| G6 | 27 | −38.88 |
| G7 | 29 | 392.42 |

### Example 4

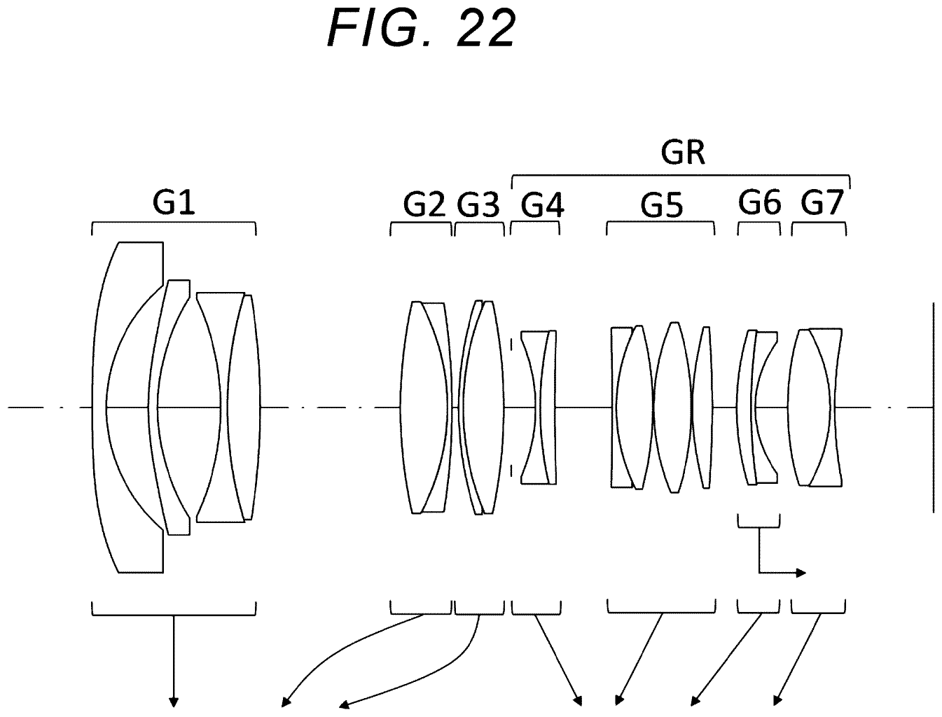

FIG. 22 is a configuration diagram of the optical system in Example 4 of the present invention.

The optical system of Example 4 consists of, in order from the object side, a first lens group G1 having a negative refractive power, a second lens group G2 having a positive refractive power, a third lens group G3 having a positive refractive power, and an image surface side lens group GR. The image surface side lens group GR consists of, in order from the object side, a fourth lens group G4 having a negative refractive power, a fifth lens group G5 having a positive refractive power, a sixth lens group G6 having a negative refractive power, and a seventh lens group G7 having a positive refractive power. An aperture diaphragm S is arranged between the third lens group G3 and the fourth lens group G4, and during variation magnification, the aperture diaphragm S moves integrally with the fourth lens group G4.

The first lens group G1 consists of, in order from the object side, a negative meniscus lens with a convex surface having a predetermined aspherical shape facing the object side, a negative meniscus lens with both surfaces having predetermined aspherical shapes and a convex surface facing the object side, and a cemented lens consisting of a biconcave lens and a biconvex lens.

The second lens group G2 consists of a cemented lens consisting of a biconvex lens and a negative meniscus lens with a convex surface facing the image surface side.

The third lens group G3 consists of a cemented lens consisting of, in order from the object side, a negative meniscus lens with a convex surface facing the object side and a biconvex lens.

The fourth lens group G4 consists of a cemented lens consisting of a biconcave lens and a positive meniscus lens with a convex surface facing the object side.

The fifth lens group G5 consists of, in order from the object side, a cemented lens consisting of a biconcave lens and a biconvex lens, a biconvex lens, and a biconvex lens with both surfaces having predetermined aspherical shapes.

The sixth lens group G6 consists of a cemented lens consisting of a positive meniscus lens with a convex surface facing the object side and a negative meniscus lens with a surface convex facing the object side. The whole sixth lens group G6 moves toward the image surface side during focusing from an infinite object distance to a close distance.

The seventh lens group G7 consists of a cemented lens consisting of a biconvex lens with a surface on the object side having a predetermined aspherical shape and a biconcave lens.

In Example 4, the variable magnification optical system experiences the following changes during variable magnification from the wide-angle end to the telephoto end: the distance between the first lens group G1 and the second lens group G2 decreases; the distance between the second lens group G2 and the third lens group G3 first increases and then decreases; the distance between the third lens group G3 and the fourth lens group G4 increases; the distance between the fourth lens group G4 and the fifth lens group G5 decreases; the distance between the fifth lens group G5 and the sixth lens group G6 decreases; the distance between the sixth lens group G6 and the seventh lens group G7 increases; and the distance between the seventh lens group G7 and the image surface increases.

Additionally, in the variable magnification optical system of Example 4, during variable magnification from the wide-angle end to the telephoto end, the first lens group G1 remains fixed relative to the image surface, while the second lens group G2 to the seventh lens group G7 each moves relative to the image surface.

Subsequently, the specifications of the optical system according to Example 4 are shown below.

Numerical Example 4
Unit: mm
[Surface data]

| Surface number | r | d | nd | νd | θgF |
|---|---|---|---|---|---|
| Object surface | ∞ | (d0) | | | |
| 1* | 500.0000 | 3.0410 | 1.59201 | 67.02 | 0.5358 |
| 2 | 37.1039 | 9.2482 | | | |
| 3* | 65.7351 | 2.0000 | 1.55332 | 71.69 | 0.5404 |
| 4* | 45.0196 | 13.9075 | | | |
| 5 | −59.7341 | 1.5000 | 1.48749 | 70.44 | 0.5306 |
| 6 | 90.6103 | 7.2805 | 1.85033 | 42.70 | 0.5646 |
| 7 | −158.4287 | (d7) | | | |
| 8 | 113.8185 | 10.3255 | 1.57144 | 71.61 | 0.5419 |
| 9 | −51.6441 | 1.0000 | 1.77047 | 29.74 | 0.5951 |
| 10 | −158.0772 | (d10) | | | |
| 11 | 79.9330 | 1.0000 | 1.75211 | 25.05 | 0.6192 |
| 12 | 62.8248 | 8.8988 | 1.59282 | 68.62 | 0.5440 |
| 13 | −118.6927 | (d13) | | | |
| 14(diaphragm) | ∞ | 5.3772 | | | |
| 15 | −40.3471 | 1.0000 | 1.77250 | 49.63 | 0.5504 |
| 16 | 79.5143 | 3.2109 | 1.98612 | 16.48 | 0.6656 |
| 17 | 458.9755 | (d17) | | | |
| 18 | −686.3201 | 0.9000 | 1.77047 | 29.74 | 0.5951 |
| 19 | 42.4979 | 8.0533 | 1.55032 | 75.50 | 0.5401 |
| 20 | −73.2713 | 0.2250 | | | |
| 21 | 51.2676 | 8.3088 | 1.59282 | 68.62 | 0.5440 |
| 22 | −64.9895 | 0.2250 | | | |
| 23* | 59.0872 | 4.3507 | 1.59201 | 67.02 | 0.5358 |
| 24* | −209.9135 | (d24) | | | |
| 25 | 62.5397 | 3.1293 | 1.98612 | 16.48 | 0.6656 |
| 26 | 123.9355 | 0.9000 | 1.80610 | 40.73 | 0.5672 |
| 27 | 25.5511 | (d27) | | | |
| 28* | 70.4488 | 9.2933 | 1.77250 | 49.50 | 0.5519 |
| 29 | −35.5253 | 1.0000 | 1.85451 | 25.15 | 0.6103 |
| 30 | 91.9834 | (BF) | | | |
| Image surface | ∞ | | | | |

[Aspherical surface data]

| | Surface 1 | Surface 3 | Surface 4 | Surface 23 | Surface 24 | Surface 28 |
|---|---|---|---|---|---|---|
| K | 0.00000 | 0.00000 | 0.00000 | 0.00000 | 0.0000 | 0.00000 |
| A4 | 3.48286E−06 | −4.20437E−06 | −1.55795E−06 | −3.63934E−06 | 1.42269E−06 | 1.47923E−06 |
| A6 | −1.63713E−09 | −1.89212E−09 | −2.02736E−09 | −1.32663E−09 | −3.14116E−10 | 6.70199E−09 |
| A8 | 5.84000E−13 | 6.01256E−12 | 4.56248E−12 | −2.25526E−12 | −4.20361E−12 | −2.86956E−11 |
| A10 | 1.07583E−16 | −2.92652E−15 | −1.24437E−15 | −7.14925E−15 | 1.07396E−14 | 9.67934E−14 |
| A12 | −2.05468E−19 | 0.00000E+00 | 0.00000E+00 | 2.35051E−17 | 0.00000E+00 | −1.03618E−16 |
| A14 | 6.55839E−23 | 0.00000E+00 | 0.00000E+00 | 0.00000E+00 | 0.00000E+00 | 0.00000E+00 |

[Various types of data]
Zoom ratio 2.05

| | Wide angle | Middle | Telephoto |
|---|---|---|---|
| Focal length | 23.69 | 33.90 | 48.50 |
| F number | 1.86 | 1.86 | 1.86 |
| Total angle of view 2ω | 90.19 | 64.73 | 46.05 |
| Image height Y | 21.63 | 21.63 | 21.63 |
| Total lens length | 185.00 | 185.00 | 185.00 |

[Variable distance data]

| | Wide angle | Middle | Telephoto |
|---|---|---|---|
| d0 | ∞ | ∞ | ∞ |
| d7 | 30.7940 | 14.3869 | 1.5000 |
| d10 | 1.4494 | 4.8874 | 1.2000 |
| d13 | 1.6433 | 15.4572 | 34.4962 |
| d17 | 12.6465 | 7.5533 | 2.4807 |
| d24 | 5.3911 | 2.9749 | 2.0000 |
| d27 | 7.1918 | 9.6080 | 10.5830 |
| BF | 21.7090 | 25.9573 | 28.5652 |

[Lens group data]

| Group | Starting surface | Focal length |
|---|---|---|
| G1 | 1 | −59.92 |
| G2 | 8 | 166.57 |
| G3 | 11 | 85.74 |
| G4 | 14 | −53.59 |
| G5 | 18 | 29.20 |
| G6 | 25 | −61.78 |
| G7 | 28 | 12794.38 |

### Example 5

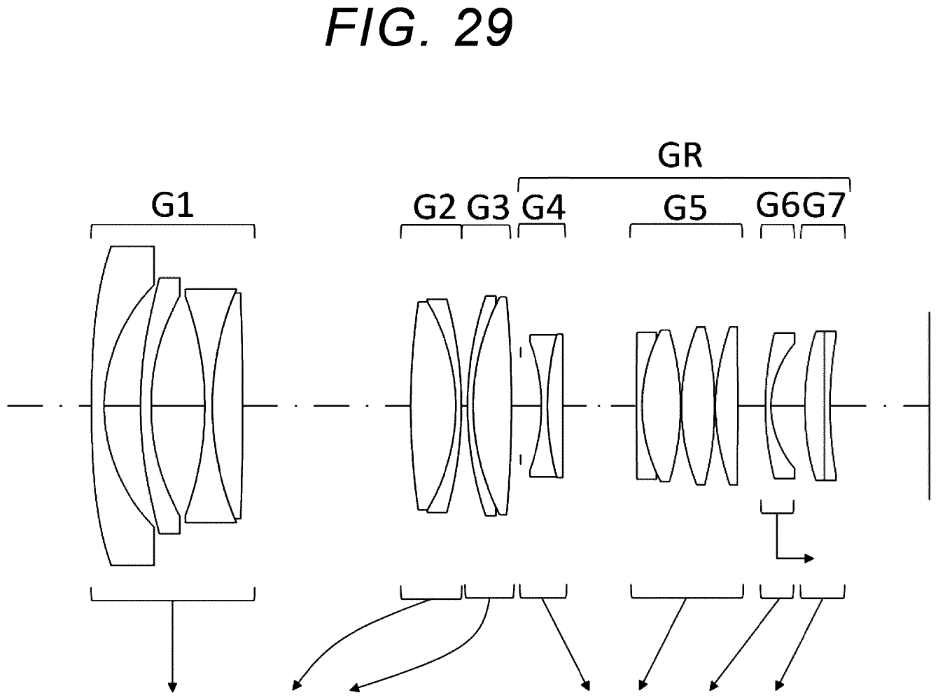

FIG. 29 is a configuration diagram of the optical system in Example 5 of the present invention.

The optical system of Example 5 consists of, in order from the object side, a first lens group G1 having a negative refractive power, a second lens group G2 having a positive refractive power, a third lens group GB having a positive refractive power, and an image surface side lens group GR. The image surface side lens group GR consists of, in order from the object side, a fourth lens group G4 having a negative refractive power, a fifth lens group G5 having a positive refractive power, a sixth lens group G6 having a negative refractive power, and a seventh lens group G7 having a positive refractive power. An aperture diaphragm S is arranged between the third lens group G3 and the fourth lens group G4, and during variation magnification, the aperture diaphragm S moves integrally with the fourth lens group G4.

The first lens group G1 consists of, in order from the object side, a negative meniscus lens with a convex surface having a predetermined aspherical shape facing the object side, a negative meniscus lens with both surfaces having predetermined aspherical shapes and a convex surface facing the object side, and a cemented lens consisting of a biconcave lens and a biconvex lens.

The second lens group G2 consists of a cemented lens consisting of a biconvex lens and a negative meniscus lens with a convex surface facing the image surface side.

The third lens group G3 consists of a cemented lens consisting of, in order from the object side, a negative meniscus lens with a convex surface facing the object side and a biconvex lens.

The fourth lens group G4 consists of a cemented lens consisting of a biconcave lens and a biconvex lens.

The fifth lens group G5 consists of, in order from the object side, a cemented lens consisting of a negative meniscus lens with a convex surface facing the object side and a biconvex lens, a biconvex lens, and a biconvex lens with both surfaces having predetermined aspherical shapes.

The sixth lens group G6 consists of a negative meniscus lens with both surfaces having predetermined aspherical shapes and a convex surface facing the object side. The whole sixth lens group G6 moves toward the image surface side during focusing from an infinite object distance to a close distance.

The seventh lens group G7 consists of a cemented lens consisting of a biconvex lens with a surface on the object side having a predetermined aspherical shape and a biconcave lens.

In Example 5, the variable magnification optical system experiences the following changes during variable magnification from the wide angle end to the telephoto end: the distance between the first lens group G1 and the second lens group G2 decreases; the distance between the second lens group G2 and the third lens group G3 first increases and then decreases; the distance between the third lens group G3 and the fourth lens group G4 increases; the distance between the fourth lens group G4 and the fifth lens group G5 decreases; the distance between the fifth lens group G5 and the sixth lens group G6 decreases; the distance between the sixth lens group G6 and the seventh lens group G7 increases; and the distance between the seventh lens group G7 and the image surface increases.

Additionally, in the variable magnification optical system of Example 5, during variable magnification from the wide-angle end to the telephoto end, the first lens group G1 remains fixed relative to the image surface, while the second lens group G2 to the seventh lens group G7 each moves relative to the image surface.

Subsequently, the specifications of the optical system according to Example 5 are shown below.

Numerical Example 5
Unit: mm
[Surface data]

| Surface number | r | d | nd | νd | θgF |
|---|---|---|---|---|---|
| Object surface | ∞ | (d0) | | | |
| 1* | 250.0000 | 2.0245 | 1.59271 | 66.97 | 0.5367 |
| 2 | 29.3085 | 5.9594 | | | |
| 3* | 79.7909 | 1.7000 | 1.55352 | 71.72 | 0.5398 |
| 4* | 43.4138 | 8.6915 | | | |
| 5 | −55.0609 | 1.2000 | 1.48749 | 70.44 | 0.5306 |
| 6 | 50.3828 | 4.9573 | 1.85033 | 42.70 | 0.5646 |
| 7 | −501.2275 | (d7) | | | |
| 8 | 125.6707 | 7.2851 | 1.57144 | 71.61 | 0.5419 |
| 9 | −34.9478 | 0.9000 | 1.77047 | 29.74 | 0.5951 |
| 10 | −68.3843 | (d10) | | | |
| 11 | 59.1788 | 0.9000 | 1.80809 | 22.76 | 0.6287 |
| 12 | 40.1403 | 6.2590 | 1.75500 | 52.32 | 0.5473 |
| 13 | −205.5648 | (d13) | | | |
| 14(diaphragm) | ∞ | 3.3947 | | | |
| 15 | −30.7802 | 0.9500 | 1.88300 | 40.81 | 0.5656 |
| 16 | 49.0857 | 2.4791 | 1.98612 | 16.48 | 0.6656 |
| 17 | −8729.0655 | (d17) | | | |
| 18 | 968.3922 | 0.9000 | 1.78880 | 28.43 | 0.6009 |
| 19 | 28.0850 | 6.2315 | 1.59282 | 68.62 | 0.5440 |
| 20 | −45.6374 | 0.1500 | | | |
| 21 | 36.7723 | 5.2950 | 1.59282 | 68.62 | 0.5440 |
| 22 | −55.1086 | 0.2500 | | | |
| 23* | 34.7999 | 3.6104 | 1.59271 | 66.97 | 0.5367 |
| 24* | −428.5708 | (d24) | | | |
| 25* | 53.7024 | 0.9000 | 1.69350 | 53.20 | 0.5467 |
| 26* | 16.1945 | (d26) | | | |
| 27* | 49.5505 | 3.1653 | 1.72903 | 54.04 | 0.5447 |
| 28 | −2028.2832 | 0.9000 | 1.85451 | 25.15 | 0.6103 |
| 29 | 70.5138 | (BF) | | | |
| Image surface | ∞ | | | | |

[Aspherical surface data]

| | Surface 1 | Surface 3 | Surface 4 | Surface 23 |
|---|---|---|---|---|
| K | 0.00000 | 0.00000 | 0.00000 | 0.00000 |
| A4 | 4.47055E−06 | 6.52127E−06 | 1.07524E−05 | −6.22097E−06 |
| A6 | −4.26254E−10 | −2.18979E−08 | −2.01293E−08 | −6.15023E−08 |
| A8 | −7.99807E−12 | 2.23821E−11 | 5.01199E−12 | 2.95996E−10 |
| A10 | 1.78158E−14 | −8.51543E−15 | 1.27037E−14 | −3.93348E−13 |
| A12 | −1.66389E−17 | 0.00000E+00 | 0.00000E+00 | −1.08960E−16 |
| A14 | 6.17964E−21 | 0.00000E+00 | 0.00000E+00 | 0.00000E+00 |

[Aspherical surface data]

| | Surface 24 | Surface 25 | Surface 26 | Surface 27 |
|---|---|---|---|---|
| K | 0.00000 | 0.00000 | 0.00000 | 0.00000 |
| A4 | 1.02264E−05 | 1.22818E−05 | 6.17901E−06 | 4.01177E−06 |
| A6 | −1.02559E−07 | −1.60748E−07 | −1.48795E−07 | 4.17665E−08 |
| A8 | 5.72026E−10 | 7.38505E−10 | 5.00972E−10 | −4.41285E−10 |
| A10 | −9.47038E−13 | −1.04189E−12 | −8.59510E−13 | 3.37838E−12 |
| A12 | 0.00000E+00 | 0.00000E+00 | 0.00000E+00 | −8.30229E−15 |
| A14 | 0.00000E+00 | 0.00000E+00 | 0.00000E+00 | 0.00000E+00 |

[Various types of data]
Zoom ratio 2.63

| | Wide angle | Middle | Telephoto |
|---|---|---|---|
| Focal length | 16.55 | 26.83 | 43.50 |
| F number | 2.06 | 2.06 | 2.06 |
| Total angle of view 2ω | 86.98 | 54.20 | 34.56 |
| Image height Y | 14.20 | 14.20 | 14.20 |
| Total lens length | 136.00 | 136.00 | 136.00 |

[Variable distance data]

| | Wide angle | Middle | Telephoto |
|---|---|---|---|
| d0 | ∞ | ∞ | ∞ |
| d7 | 27.3034 | 9.5005 | 1.2000 |
| d10 | 1.0051 | 7.0982 | 1.0000 |
| d13 | 1.5000 | 15.7737 | 31.2158 |
| d17 | 11.9908 | 6.9263 | 0.7272 |
| d24 | 4.5046 | 3.5277 | 1.6000 |
| d26 | 5.4813 | 6.4582 | 8.3859 |
| BF | 16.1120 | 18.6126 | 23.7683 |

[Lens group data]

| Group | Starting surface | Focal length |
|---|---|---|
| G1 | 1 | −41.83 |
| G2 | 8 | 99.93 |
| G3 | 11 | 63.18 |
| G4 | 14 | −37.82 |
| G5 | 18 | 19.66 |
| G6 | 25 | −33.77 |
| G7 | 27 | 339.33 |

### Example 6

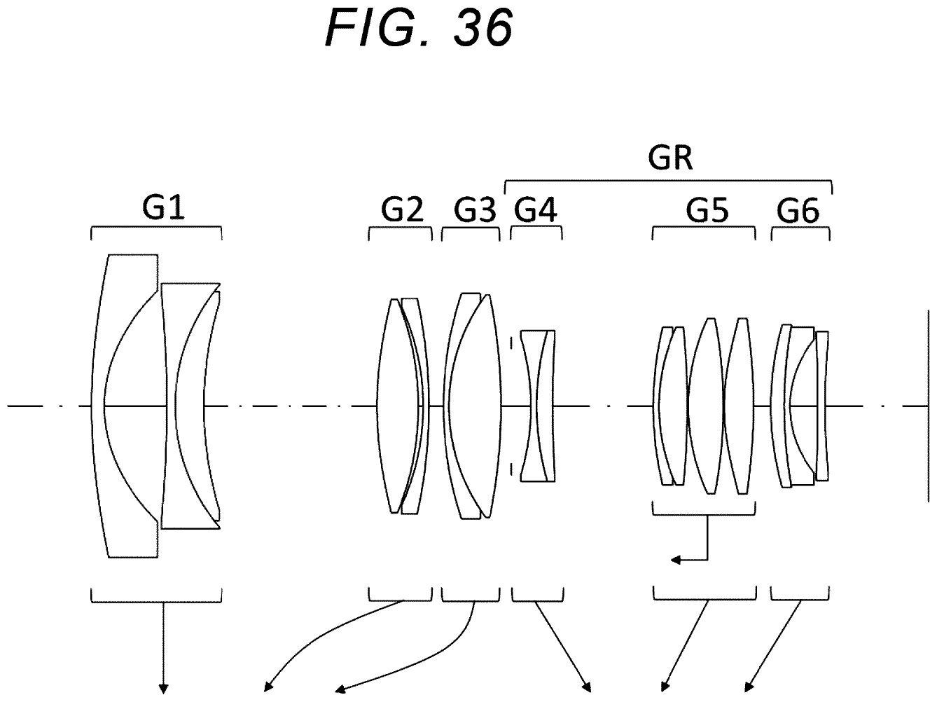

FIG. 36 is a configuration diagram of the optical system in Example 6 of the present invention.

The optical system of Example 6 consists of, in order from the object side, a first lens group G1 having a negative refractive power, a second lens group G2 having a positive refractive power, a third lens group G3 having a positive refractive power, and an image surface side lens group GR. The image surface side lens group GR consists of, in order from the object side, a fourth lens group G4 having a negative refractive power, a fifth lens group G5 having a positive refractive power, and a sixth lens group G6 having a negative refractive power. An aperture diaphragm S is arranged between the third lens group G3 and the fourth lens group G4, and during variation magnification, the aperture diaphragm S moves integrally with the fourth lens group G4.

The first lens group G1 consists of, in order from the object side, a negative meniscus lens with both surfaces having predetermined aspherical shapes and a convex surface facing the object side, and a cemented lens consisting of a biconcave lens and a biconvex lens.

The second lens group G2 consists of a biconvex lens with both surfaces having predetermined aspherical shapes and a negative meniscus lens with a convex surface facing the image surface side.

The third lens group G3 consists of a cemented lens consisting of, in order from the object side, a negative meniscus lens with a convex surface facing the object side and a biconvex lens.

The fourth lens group G4 consists of a cemented lens consisting of a biconcave lens and a positive meniscus lens with a convex surface facing the object side.

The fifth lens group G5 consists of, in order from the object side, a cemented lens consisting of a negative meniscus lens with a convex surface facing the object side and a biconvex lens, a biconvex lens, and a biconvex lens with both surfaces having predetermined aspherical shapes. The whole fifth lens group G5 moves toward the object side during focusing from an infinite object distance to a close distance.

The sixth lens group G6 consists of, in order from the object side, a cemented lens consisting of a positive meniscus lens with a convex surface facing the object side and a negative meniscus lens with a convex surface facing the object side, and a biconcave lens with both surfaces having predetermined aspherical shapes.

In Example 6, the variable magnification optical system experiences the following changes during variable magnification from the wide-angle end to the telephoto end: the distance between the first lens group G1 and the second lens group G2 decreases; the distance between the second lens group G2 and the third lens group G3 first increases and then decreases; the distance between the third lens group G3 and the fourth lens group G4 increases; the distance between the fourth lens group G4 and the fifth lens group G5 decreases; the distance between the fifth lens group G5 and the sixth lens group G6 changes; and the distance between the sixth lens group G6 and the image surface increases.

Additionally, in the variable magnification optical system of Example 6, during variable magnification from the wide-angle end to the telephoto end, the first lens group G1 remains fixed relative to the image surface, while the second lens group G2 to the sixth lens group G6 each moves relative to the image surface.

Subsequently, the specifications of the optical system according to Example 6 are shown below.

Numerical Example 6
Unit: mm
[Surface data]

| Surface number | r | d | nd | νd | θgF |
|---|---|---|---|---|---|
| Object surface | ∞ | (d0) | | | |
| 1* | 103.7010 | 2.0000 | 1.69350 | 53.20 | 0.5467 |
| 2* | 22.9882 | 9.8673 | | | |
| 3 | −200.0000 | 1.3300 | 1.43700 | 95.10 | 0.5336 |
| 4 | 31.3342 | 4.5273 | 1.85451 | 25.15 | 0.6103 |
| 5 | 59.9759 | (d5) | | | |
| 6* | 62.3752 | 6.5089 | 1.55332 | 71.69 | 0.5404 |
| 7* | −48.6789 | 0.7545 | | | |
| 8 | −40.1587 | 0.9000 | 1.77047 | 29.74 | 0.5951 |
| 9 | −84.4685 | (d9) | | | |
| 10 | 59.7543 | 0.9000 | 1.85451 | 25.15 | 0.6103 |
| 11 | 31.0637 | 8.2482 | 1.72916 | 54.67 | 0.5453 |
| 12 | −92.1898 | (d12) | | | |
| 13(diaphragm) | ∞ | 3.0696 | | | |
| 14 | −40.0833 | 0.9500 | 1.83400 | 37.34 | 0.5790 |
| 15 | 45.4198 | 2.5009 | 1.98612 | 16.48 | 0.6656 |
| 16 | 190.2359 | (d16) | | | |
| 17 | 57.0815 | 0.9000 | 1.85451 | 25.15 | 0.6103 |
| 18 | 31.7140 | 4.4777 | 1.48071 | 85.29 | 0.5362 |
| 19 | −130.1923 | 0.1500 | | | |
| 20 | 35.1735 | 5.5385 | 1.55032 | 75.50 | 0.5401 |
| 21 | −75.8961 | 0.1500 | | | |
| 22* | 37.8578 | 4.5896 | 1.55332 | 71.69 | 0.5404 |
| 23* | −80.5700 | (d23) | | | |
| 24 | 50.2507 | 2.0923 | 2.00069 | 25.46 | 0.6136 |
| 25 | 77.2723 | 0.9000 | 1.62205 | 41.08 | 0.5690 |
| 26 | 17.2780 | 4.3945 | | | |
| 27* | −687.6936 | 1.1576 | 1.68893 | 31.16 | 0.6038 |
| 28* | 92.8435 | (BF) | | | |
| Image surface | ∞ | | | | |

[Aspherical surface data]

| | Surface 1 | Surface 2 | Surface 6 | Surface 7 |
|---|---|---|---|---|
| K | 0.00000 | 0.00000 | 0.00000 | 0.00000 |
| A4 | 1.38184E−06 | −2.47952E−06 | −2.47854E−06 | −1.52958E−06 |
| A6 | −1.37202E−08 | −2.08490E−08 | 1.07213E−09 | 1.59528E−09 |
| A8 | 3.49324E−11 | −5.96343E−12 | −5.26923E−12 | −5.20292E−12 |
| A10 | −4.29829E−14 | 6.55077E−14 | 0.00000E+00 | 0.00000E+00 |
| A12 | 2.17686E−17 | −1.77729E−16 | 0.00000E+00 | 0.00000E+00 |

[Aspherical surface data]

| | Surface 22 | Surface 23 | Surface 27 | Surface 28 |
|---|---|---|---|---|
| K | 0.00000 | 0.00000 | 0.00000 | 0.00000 |
| A4 | −1.02375E−05 | 9.67871E−06 | −1.16170E−05 | −1.11984E−05 |
| A6 | −1.51606E−08 | −4.52747E−08 | 5.98165E−08 | 6.36589E−08 |
| A8 | −8.46224E−11 | 1.71230E−10 | −5.10795E−10 | −6.08054E−10 |
| A10 | 6.11902E−13 | −2.39676E−13 | 1.61285E−12 | 1.55909E−12 |
| A12 | −1.13199E−15 | 0.00000E+00 | 0.00000E+00 | 0.00000E+00 |

[Various types of data]
Zoom ratio 2.22

| | Wide angle | Middle | Telephoto |
|---|---|---|---|
| Focal length | 17.51 | 26.07 | 38.80 |
| F number | 1.86 | 1.86 | 1.86 |
| Total angle of view 2ω | 83.30 | 56.82 | 38.45 |
| Image height Y | 14.20 | 14.20 | 14.20 |
| Total lens length | 132.00 | 132.00 | 132.00 |

[Variable distance data]

| | Wide angle | Middle | Telephoto |
|---|---|---|---|
| d0 | ∞ | ∞ | ∞ |
| d5 | 27.3091 | 14.3706 | 6.2365 |
| d9 | 2.2963 | 7.1073 | 1.4000 |
| d12 | 1.6132 | 12.7162 | 30.2082 |
| d16 | 15.8523 | 9.7321 | 4.6975 |
| d23 | 2.7485 | 1.5000 | 1.5000 |
| BF | 16.2735 | 20.6669 | 22.0508 |

[Lens group data]

| Group | Starting surface | Focal length |
|---|---|---|
| G1 | 1 | −36.52 |
| G2 | 6 | 97.39 |
| G3 | 10 | 56.31 |
| G4 | 13 | −43.91 |
| G5 | 17 | 21.17 |
| G6 | 24 | −34.66 |

### Example 7

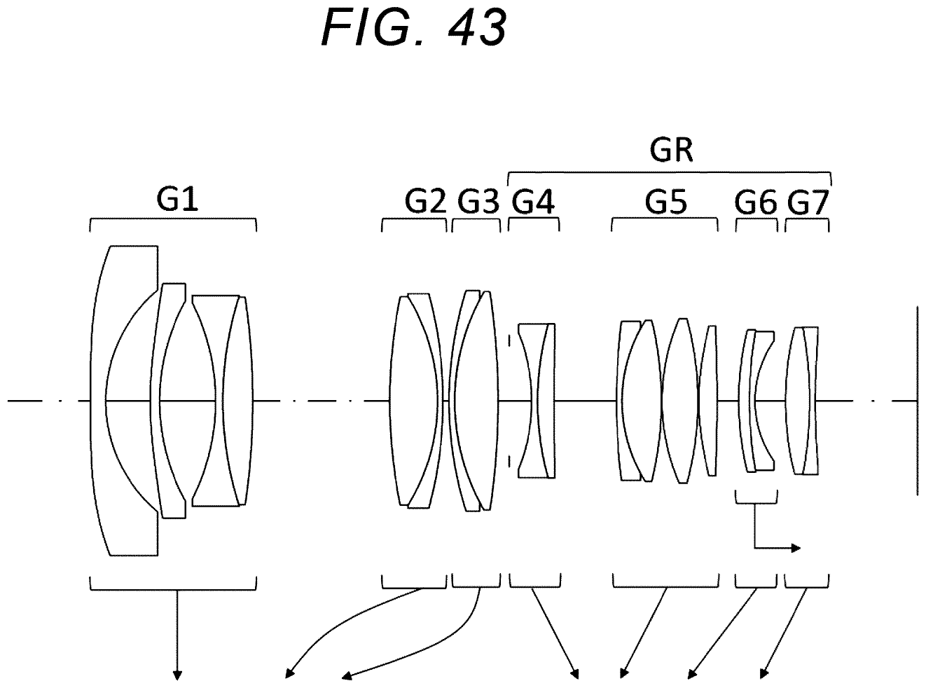

FIG. 43 is a configuration diagram of the optical system in Example 7 of the present invention.

The optical system of Example 7 consists of, in order from the object side, a first lens group G1 having a negative refractive power, a second lens group G2 having a positive refractive power, a third lens group G3 having a positive refractive power, and an image surface side lens group GR. The image surface side lens group GR consists of, in order from the object side, a fourth lens group G4 having a negative refractive power, a fifth lens group G5 having a positive refractive power, a sixth lens group G6 having a negative refractive power, and a seventh lens group G7 having a positive refractive power. An aperture diaphragm S is arranged between the third lens group G3 and the fourth lens group G4, and during variation magnification, the aperture diaphragm S moves integrally with the fourth lens group G4.

The first lens group G1 consists of, in order from the object side, a negative meniscus lens with a convex surface having a predetermined aspherical shape facing the object side, a negative meniscus lens with both surfaces having predetermined aspherical shapes and a convex surface facing the object side, and a cemented lens consisting of a biconcave lens and a biconvex lens.

The second lens group G2 consists of a cemented lens consisting of a biconvex lens and a negative meniscus lens with a convex surface facing the image surface side.

The third lens group G3 consists of a cemented lens consisting of, in order from the object side, a negative meniscus lens with a convex surface facing the object side and a biconvex lens.

The fourth lens group G4 consists of a cemented lens consisting of a biconcave lens and a positive meniscus lens with a convex surface facing the object side.

The fifth lens group G5 consists of, in order from the object side, a cemented lens consisting of a negative meniscus lens with a convex surface facing the object side and a biconvex lens, a biconvex lens, and a biconvex lens with both surfaces having predetermined aspherical shapes.

The sixth lens group G6 consists of a cemented lens consisting of a positive meniscus lens with a convex surface facing the object side and a negative meniscus lens with a surface convex facing the object side. The whole sixth lens group G6 moves toward the image surface side during focusing from an infinite object distance to a close distance.

The seventh lens group G7 consists of a cemented lens consisting of a biconvex lens with a surface on the object side having a predetermined aspherical shape and a biconcave lens.

In Example 7, the variable magnification optical system experiences the following changes during variable magnification from the wide-angle end to the telephoto end: the distance between the first lens group G1 and the second lens group G2 decreases; the distance between the second lens group G2 and the third lens group G3 first increases and then decreases; the distance between the third lens group G3 and the fourth lens group G4 increases; the distance between the fourth lens group G4 and the fifth lens group G5 decreases; the distance between the fifth lens group G5 and the sixth lens group G6 decreases; the distance between the sixth lens group G6 and the seventh lens group G7 increases; and the distance between the seventh lens group G7 and the image surface increases.

Additionally, in the variable magnification optical system of Example 7, during variable magnification from the wide-angle end to the telephoto end, the first lens group G1 remains fixed relative to the image surface, while the second lens group G2 to the seventh lens group G7 each moves relative to the image surface.

Subsequently, the specifications of the optical system according to Example 7 are shown below.

Numerical Example 7
Unit: mm
[Surface data]

| Surface number | r | d | nd | νd | θgF |
|---|---|---|---|---|---|
| Object surface | ∞ | (d0) | | | |
| 1* | 1000.0000 | 2.4290 | 1.59201 | 67.02 | 0.5358 |
| 2 | 24.3925 | 7.1926 | | | |
| 3* | 66.2946 | 1.5000 | 1.41390 | 101.00 | 0.5340 |
| 4* | 36.1614 | 8.9612 | | | |
| 5 | −37.3937 | 1.2000 | 1.48749 | 70.44 | 0.5306 |
| 6 | 59.0660 | 4.7981 | 1.85033 | 42.70 | 0.5646 |
| 7 | −120.0107 | (d7) | | | |
| 8 | 87.7376 | 7.6542 | 1.55032 | 75.50 | 0.5401 |
| 9 | −34.0835 | 0.9000 | 1.76634 | 35.82 | 0.5792 |
| 10 | −69.4930 | (d10) | | | |
| 11 | 62.9821 | 0.9000 | 1.80809 | 22.76 | 0.6287 |
| 12 | 37.2090 | 6.9916 | 1.72916 | 54.67 | 0.5453 |
| 13 | −125.8585 | (d13) | | | |
| 14(diaphragm) | ∞ | 3.6363 | | | |
| 15 | −30.8799 | 0.9500 | 1.88300 | 40.81 | 0.5656 |
| 16 | 49.0961 | 2.6492 | 1.98612 | 16.48 | 0.6656 |
| 17 | 1120.8255 | (d17) | | | |
| 18 | 108.0580 | 0.9000 | 1.77047 | 29.74 | 0.5951 |
| 19 | 25.9194 | 6.2587 | 1.55032 | 75.50 | 0.5401 |
| 20 | −58.1625 | 0.1500 | | | |
| 21 | 34.9619 | 5.7498 | 1.59282 | 68.62 | 0.5440 |
| 22 | −53.0417 | 0.1500 | | | |
| 23* | 41.5257 | 2.9825 | 1.59201 | 67.02 | 0.5358 |
| 24* | −223.4571 | (d24) | | | |
| 25 | 50.4471 | 1.7510 | 1.98612 | 16.48 | 0.6656 |
| 26 | 67.4639 | 0.9000 | 1.90043 | 37.37 | 0.5767 |
| 27 | 17.9849 | (d27) | | | |
| 28* | 57.1827 | 3.8815 | 1.77250 | 49.50 | 0.5519 |
| 29 | −67.4839 | 0.9000 | 1.85451 | 25.15 | 0.6103 |
| 30 | 137.0342 | (BF) | | | |
| Image surface | ∞ | | | | |

[Aspherical surface data]

| | Surface 1 | Surface 3 | Surface 4 | Surface 23 | Surface 24 | Surface 28 |
|---|---|---|---|---|---|---|
| K | 0.00000 | 0.00000 | 0.00000 | 0.00000 | 0.00000 | 0.00000 |
| A4 | 1.15367E−05 | −7.30479E−06 | 4.36057E−06 | −8.13543E−06 | 7.84491E−06 | 3.80020E−06 |
| A6 | −1.38785E−08 | −1.39626E−08 | −1.86810E−08 | −2.38208E−08 | −3.45877E−08 | 5.25127E−08 |
| A8 | 1.39602E−11 | 6.44220E−11 | 3.85249E−11 | 3.00844E−11 | 1.53605E−10 | −6.17941E−10 |
| A10 | −6.80777E−15 | −6.00025E−14 | −1.27425E−14 | 2.17025E−13 | −1.76605E−13 | 4.73032E−12 |
| A12 | −1.56526E−18 | 0.00000E+00 | 0.00000E+00 | −4.18280E−16 | 0.00000E+00 | −1.22536E−14 |
| A14 | 2.63343E−21 | 0.00000E+00 | 0.00000E+00 | 0.00000E+00 | 0.00000E+00 | 0.00000E+00 |

[Various types of data]
Zoom ratio 2.2

| | Wide angle | Middle | Telephoto |
|---|---|---|---|
| Focal length | 15.45 | 22.90 | 33.95 |
| F number | 1.86 | 1.86 | 1.86 |
| Total angle of view 2ω | 90.57 | 62.24 | 43.46 |
| Image height Y | 14.20 | 14.20 | 14.20 |
| Total lens length | 133.00 | 133.00 | 133.00 |

[Variable distance data]

| | Wide angle | Middle | Telephoto |
|---|---|---|---|
| d0 | ∞ | ∞ | ∞ |
| d7 | 22.0370 | 8.8612 | 1.2000 |
| d10 | 1.0000 | 4.4331 | 1.0000 |
| d13 | 1.7858 | 13.3366 | 25.3996 |
| d17 | 10.0290 | 6.0819 | 1.0000 |
| d24 | 3.4516 | 2.6940 | 1.5000 |
| d27 | 4.8875 | 5.6451 | 6.8392 |
| BF | 16.4234 | 18.5622 | 22.6754 |

[Lens group data]

| Group | Starting surface | Focal length |
|---|---|---|
| G1 | 1 | −35.20 |
| G2 | 8 | 92.45 |
| G3 | 11 | 61.62 |
| G4 | 14 | −36.51 |
| G5 | 18 | 19.87 |
| G6 | 25 | −32.82 |
| G7 | 28 | 158.32 |

The conditional expression corresponding values corresponding to the respective examples are shown below.

### Conditional Expression Corresponding Value

### Conditional Expressions/Examples EX1 EX2 EX3 EX4 EX5 EX6 EX7

| | | | | | | | |
|---|---|---|---|---|---|---|---|
| (1) | 0.00 | 0.00 | 0.00 | −0.01 | 0.00 | −0.04 | 0.00 |
| (2) | 0.16 | 0.16 | 0.14 | 0.12 | 0.23 | 0.23 | 0.16 |
| (3) | 0.16 | 0.16 | 0.14 | 0.13 | 0.23 | 0.27 | 0.16 |
| (4) | 1.21 | 1.21 | 1.23 | 1.12 | 1.14 | 1.36 | 1.13 |
| (5) | 0.00 | 0.00 | 0.00 | 0.00 | 0.00 | 0.00 | 0.00 |
| (6) | 0.00 | 0.00 | 0.00 | 0.00 | 0.00 | 0.00 | 0.00 |
| (7) | 0.31 | 0.31 | 0.34 | 0.31 | 0.31 | 0.29 | 0.35 |
| (8) | 0.027 | 0.023 | 0.027 | 0.022 | 0.022 | 0.021 | 0.032 |
| (9) | 0.021 | 0.022 | 0.020 | 0.026 | 0.019 | 0.027 | 0.025 |
| (10) | −0.42 | −0.40 | −0.40 | −0.40 | −0.40 | −0.48 | −0.44 |
| (11) | 0.48 | 0.46 | 0.44 | 0.29 | 0.44 | 0.40 | 0.37 |
| (12) | 0.51 | 0.50 | 0.53 | 0.57 | 0.69 | 0.69 | 0.55 |
| (13) | −0.96 | −0.96 | −0.95 | −0.91 | −1.15 | −0.88 | −0.93 |
| (14) | 2.21 | 2.21 | 2.21 | 2.05 | 2.63 | 2.22 | 2.20 |
| (15) | 1.86 | 1.86 | 1.86 | 1.86 | 2.06 | 1.86 | 1.86 |

### Other Embodiments

The technology disclosed in the present example is not limited to the description of the above-described embodiment and examples, and various modification implementations can be made. The shapes and numerical values of each part shown in the above-described numerical examples are merely examples for carrying out the present technology, and the technical scope of the present technology is not limited thereto.

In the above-described embodiments and examples, configurations including six or seven lens groups have been described, but configurations including lenses that substantially have no refractive power may also be employed.

It goes without saying that various modifications, combinations, sub-combinations, and changes may be conceived by those skilled in the art in accordance with design requirements or other factors, and such variations are to be included within the scope of the appended claims and their equivalents.

### DESCRIPTION OF REFERENCE NUMERALS AND SIGNS

G1: first lens group
G2: second lens group
G3: third lens group
G4: fourth lens group
G5: fifth lens group
G6: sixth lens group
G7: seventh lens group
GR: image surface side lens group
S: aperture diaphragm
I: image surface
C: Cray (wavelength λ=656.3 nm)
d: d ray (wavelength λ=587.6 nm)
g: g ray (wavelength)=435.8 nm)
Y: image height
ΔS: sagittal image surface
ΔM: meridional image surface

What is claimed is:

1. A variable magnification optical system comprising,
in order from an object side:
a first lens group G1 having a negative refractive power;
a second lens group G2 having a positive refractive power;
a third lens group G3 having a positive refractive power; and
an image surface side lens group GR,
wherein, during variable magnification from a wide-angle end to a telephoto end:
an air distance between the first lens group G1 and the second lens group G2 decreases;
an air distance between the second lens group G2 and the third lens group G3 changes; and
an air distance between the third lens group G3 and the image surface side lens group GR increases, and the optical system satisfies following conditional expressions:
$$- 0.08 < ( D 23 T - D 23 W ) / ( D 12 W - D 12 T ) < 0.08 ; \qquad ( 1 )$$
$$0.08 < ( D 23 N - D 23 W ) / ( D 12 W - D 12 T ) < 0.4 ; \qquad ( 2 )$$
$$0.08 < ( D 23 N - D 23 T ) / ( D 12 W - D 12 T ) < 0.4 ; and \qquad ( 3 )$$
$$0.5 < ( D 34 T - D 34 W ) / ( D 12 W - D 12 T ) < 2. ; \qquad ( 4 )$$
where:
D12W is a distance between the first lens group G1 and the second lens group G2 at a wide-angle end;
D12T is a distance between the first lens group G1 and the second lens group G2 at a telephoto end;
D23W is a distance between the second lens group G2 and the third lens group G3 at the wide-angle end;
D23N is a distance between the second lens group G2 and the third lens group G3 at an intermediate variable magnification state;
D23T is a distance between the second lens group G2 and the third lens group G3 at the telephoto end;
D34W is a distance between the third lens group G3 and the image surface side lens group GR at the wide-angle end;
D34T is a distance between the third lens group G3 and the image surface side lens group GR at the telephoto end;
fw is a focal length of entire lens system at the wide-angle end when focused at infinity;
ft is a focal length of the entire lens system at the telephoto end when focused at infinity; and
the intermediate variable magnification state refers to a state in which the focal length of the entire optical system, due to variable magnification, is equal to or near √(fw×ft).

2. The variable magnification optical system according to claim 1,
wherein the optical system satisfies following conditional expressions:
$$- 0.04 < ( L T N - L TW ) / < 0.06 ; and \qquad ( 5 )$$
$$- 0.06 < ( L T T - L TW ) / LTW < 0.08 ; \qquad ( 6 )$$
where:
LTW is a total lens length at the wide-angle end;
LTN is a total lens length at an intermediate variable magnification state; and
LTT is a total lens length at the telephoto end.

3. The variable magnification optical system according to claim 1,
wherein the first lens group G1 remains fixed during variable magnification.

4. The variable magnification optical system according to claim 1,
wherein the first lens group G1 includes at least one lens having a positive refractive power and at least two lenses each having a negative refractive power, and the optical system satisfies following conditional expression:
$$0.20 < ndPG 1 - ndNG 1 < 0.45 ; \qquad ( 7 )$$
where:
ndPG1 is the mean value of the refractive indices at the d line wavelength of the lenses having a positive refractive power arranged in the first lens group G1; and
ndNG1 is the mean value of the refractive indices at the d line wavelength of the lenses each having a negative refractive power arranged in the first lens group G1.

5. The variable magnification optical system according to claim 1,
wherein the second lens group G2 includes at least one lens having a positive refractive power and at least one lens having a negative refractive power, and the optical system satisfies following conditional expression:
$$dPgPG 2 - dPgNG 2 > 0.01 ; \qquad ( 8 )$$
where:
dPgPG2 is a mean value of deviations of the partial dispersion ratios with respect to the g line of the lenses having a positive refractive power arranged in the second lens group G2;
dPgNG2 is a mean value of deviations of the partial dispersion ratios with respect to the g line of the lenses having a negative refractive power arranged in the second lens group G2; and
deviation dPgF of the partial dispersion ratio with respect to the g line is calculated for each lens using the partial dispersion ratio θgF with respect to the g line and the Abbe number vd at the d line, as follows:
dPgF=0gF−(0.648285−0.00180123×vd).

6. The variable magnification optical system according to claim 1,
wherein the image surface side lens group GR includes at least one lens having a positive refractive power and at least one lens having a negative refractive power, and the optical system satisfies following conditional expression:
$$dPgPGR - dPgNGR > 0.01 ; \qquad ( 9 )$$
where:
dPgPGR is a mean value of deviations of partial dispersion ratios with respect to the g line of the lenses having a positive refractive power arranged in the image surface side lens group GR;
dPgNGR is a mean value of the deviations of partial dispersion ratios with respect to the g line of the lenses having negative refractive power arranged in the image surface side lens group GR; and
the deviation dPgF of the partial dispersion ratio with respect to the g line is calculated for each lens using the partial dispersion ratio θgF with respect to the g line and the Abbe number vd at the d line, as follows:
$$dPgF = θg F - ( 0.648285 - 0.00180123 \times vd ) .$$

7. The variable magnification optical system according to claim 1,
wherein the optical system satisfies following conditional expressions:
$$- 0.6 < fw / f 1 < - 0.3 ; \qquad ( 10 )$$
$$0.2 < ft / f 2 < 0.6 ; and \qquad ( 11 )$$
$$0.4 < ft / f 3 < 0.8 ; \qquad ( 12 )$$
where:
fw is the focal length of the entire lens system at the wide-angle end when focused at infinity;
ft is the focal length of the entire lens system at the telephoto end when focused at infinity;
f1 is a focal length of the first lens group G1;
f2 is a focal length of the second lens group G2; and
f3 is a focal length of the third lens group G3.

8. The variable magnification optical system according to claim 1,
wherein the image surface side lens group GR includes, in order from the object side, a fourth lens group G4 having a negative refractive power and a fifth lens group G5 having a positive refractive power.

9. The variable magnification optical system according to claim 8,
wherein the optical system satisfies following conditional expression:
$$- 1.4 < ft / f 4 < - 0.7 ; \qquad ( 13 )$$
where:
ft is the focal length of the entire lens system at the telephoto end when focused at infinity; and
f4 is the focal length of the fourth lens group G4.

10. The variable magnification optical system according to claim 1,
wherein the optical system satisfies following conditional expression:
$$1.75 < ft / fw < 3.5 ; \qquad ( 14 )$$
where:
fw is the focal length of the entire lens system at the wide-angle end when focused at infinity; and
ft is the focal length of the entire lens system at the telephoto end when focused at infinity.

11. The variable magnification optical system according to claim 1,
wherein the optical system satisfies following conditional expression:
$$1. 40 \leq Fnot \leq 2.8 ; \qquad ( 15 )$$
where:
Fnot is the F number of the entire lens system at the telephoto end when focused at infinity.
